(19) United States
(12) Patent Application Publication
(10) Pub. No.: US 2012/0002008 A1
(43) Pub. Date: Jan. 5, 2012

(54) Apparatus for secure recording and transformation of images to light for identification, and audio visual projection to spatial point targeted area

(76) Inventors: David Valin, Flushing, NY (US); Alex Socolof, Briarcliff Manor, NY (US)

(21) Appl. No.: 12/830,344

(22) Filed: Jul. 4, 2010

(51) Int. Cl. H04N 15/00; G06F 15/16

(52) U.S. Cl. 348/43; 709/219; 348/E13.014

(57) ABSTRACT

The current invention presented here is an apparatus for securely managed recording, transformation, storage, and projection of digital or quantum media images and video by a server transforming laser light into a standalone or reflected audio video spatial point targeted display in free space, or reflected surface, for virtual or non virtual viewing and listening. The method and mechanism presented allows any individual or groups to view and listen to content in any space managed by an Illumination Transformer Audio Video Manager Interactive Server Transmitter (ITAVMIST) server, GSense H3DVARVP-IL or high resolution devices, goggles, glasses or without devices, and be able to view, video and listen to sound, in binaural stereo and 2D 3D video. The present invention also enables recording and transformations of audio and video with GSense H3DVARVP devices, goggles, glasses or other viewing device configurations, transmitted wireless or infrared to an ITAVMIST server for processing, transformation and transmission to spatial point targets in free space for viewing in virtual spaces or non virtual spaces.

### TECHNICAL FIELD

The present invention relates to multiple colored pixel cameras and a plurality of laser projector mechanisms server devices and, to laser light beams for 2D and 3D virtual displays in free space and human immersion sensing devices for vision, hearing, smell, touch and taste utilized for recording, protection, security, projection, licensing, managing, and identifying an owner, and ownership of content in a digital or quantum computer media environment, and a secure management of the distribution grid of network node(s) for parallel processing and optimum management of data.

### BACKGROUND OF THE INVENTION

Dependent technologies are presented here for providing visual displays of graphical or video images to a user, utilizing devices for viewing and interactions with other users, places, or things in the main network. Technologies also are presented here that allow users to record events with parallel server mechanism connected devices, and protect them so that users can license and market them to other users in a virtual or real world.

One problem that exists today is that having a real world virtual experience requires large processing power, and bulky equipment for viewing and listening. Utilizing a grid based managed application, simplifies the processing that the user needs at the targeted point of experience when viewing and listening. Furthermore utilizing a grid parallel supercomputer that is connected to a vast network, enables that faster processing can be shared across the network.

Several problems come up when using a virtual system with a grid parallel processor, some examples are: security, protection of content, identifying content in a vast network, removing content, allowing content to be viewed, and trust of a network system to protect your virtual and real world privacy, and virtual and real world content in a mass market network system.

The invention utilizes the solar panel wind turbine communication server network apparatus method and mechanism. from U.S. patent application Ser. No. 12/768,981, filed on Apr. 28, 2010 connected to the Illumination Transformer Audio Video Manager Interactive Server Transmitter (ITAVMIST) server, and functions with banking in a virtual and real world, for virtual and real world secure connections, protected by the Protect Anything Human Key where you are the card, and the mechanism utilizes a users facial surface, and speech patterns, combined with infra red distance 3D modeling identification and projection to a free space background, and 3D modeling mechanism, which transforms the user into the actual identification mechanism for purchasing, ownership rights, agreements, sharing of content, and secure virtual and digital rights management.

The invention further utilizes U.S. patent application Ser. No. 12/459,353, filed on Jun. 29, 2009, Method and mechanism for protection, sharing, storage, accessing, authentication, certification, attachment and tracking anything in an electronic network, and U.S. patent application Ser. No. 12/653,749, filed on Dec. 17, 2009, Method and mechanism for identifying protecting, requesting, assisting and managing information, and are integrated into the current invention for managing and assisting in protecting, storage and processing of real and virtual world digital and quantum computer files, media, images, video, and data. It accomplishes this utilization by attaching an authorized Protect Anything Human Key to all objects, text, data, images, video, audio, and representations of people, things, or worlds including payments and transactions.

In one aspect, the invention features a method including a way for users to collaborate in building better virtual world communities, for commerce, recreation, assisting people, raising money, virtual parties, and/or conferences, combined with real world energy creation, and virtual or real world banking and energy marketing and management.

In one embodiment, the scanning mechanism scans your face, and asks for audio verification, and anything that is connected to that human key can have permissions to work such as door locks, credit card payments, links to medical records, surgery authorization, as trust is built into the mechanism with the human key.

In another embodiment of the mechanism, other members of a users group, or family and friends, can be connected into your human key information, in defined access zones, with the users permission, for tracking and keeping up with individuals in a virtual network, or real world environment.

### SPECIFICATIONS

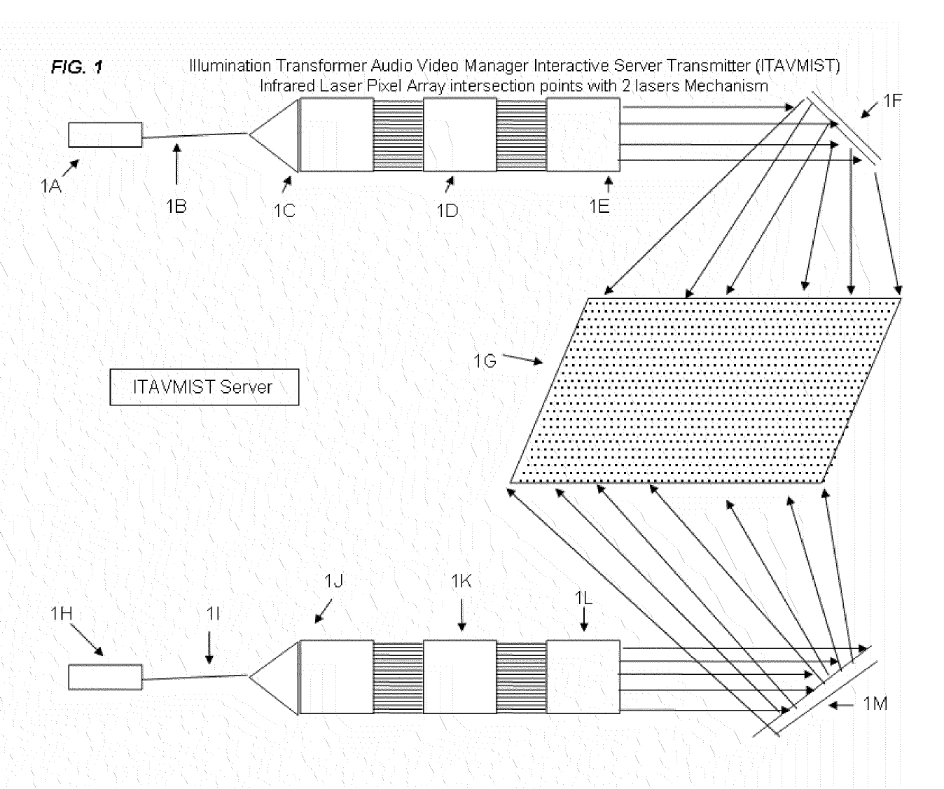

FIG. 1 is a conceptual diagram representative of Illumination Transformer Audio Video Manager Interactive Server Transmitter (ITAVMIST) Infrared Laser Pixel Array intersection points with 2 lasers mechanism.

FIG. 1A is an illustration representative showing the infrared light laser part of the mechanism.

FIG. 1B is an illustration representative showing the infrared light laser beam part of the mechanism.

FIG. 1C is an illustration representative showing the fiber optic splitter multiplier part of the mechanism.

FIG. 1D is an illustration representative showing the collimator for focusing beams part of the mechanism.

FIG. 1 E is an illustration representative showing the laser filter block beam or allow beam switching part of the mechanism.

FIG. 1F is an illustration representative showing the infrared light laser beam reflected off mirrors part of the mechanism.

FIG. 1G is an illustration representative showing the infrared light laser free space intersect points pixel plasma grid of the mechanism.

FIG. 1H is an illustration representative showing the second infrared light laser part of the mechanism.

FIG. 1I is an illustration representative showing the second infrared light laser beam part of the mechanism.

FIG. 1J is an illustration representative showing the second fiber optic splitter multiplier part of the mechanism.

FIG. 1K is an illustration representative showing the second collimator for focusing beams of the mechanism.

FIG. 1L is an illustration representative showing the second laser filter block beam or allow beam switching part of the mechanism.

FIG. 1M is an illustration representative showing the second infrared light laser beam reflected off mirrors part of the mechanism.

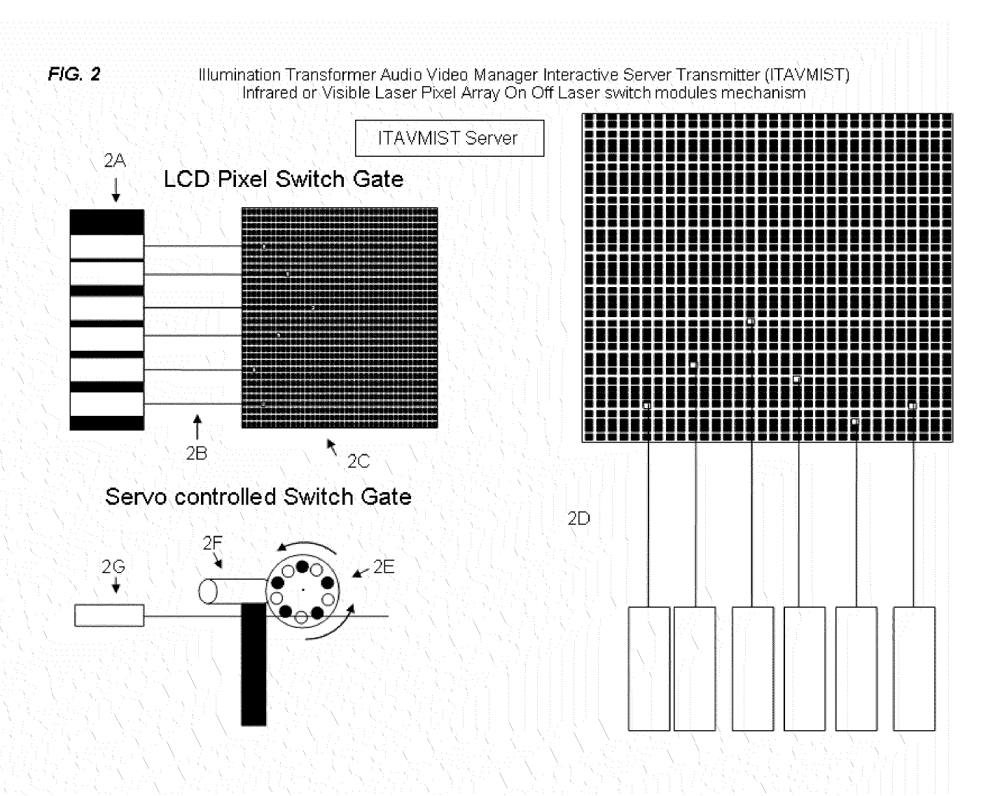

FIG. 2 is a conceptual diagram representative of the Illumination Transformer Audio Video Manager Interactive Server Transmitter (ITAVMIST)Infrared or Visible Laser Pixel Array On Off Laser switch modules mechanism.

FIG. 2A is an illustration representative showing the LCD Pixel Switch Gate laser part of the mechanism.

FIG. 2B is an illustration representative showing the LCD Pixel Switch Gate laser beam part of the mechanism.

FIG. 2C is an illustration representative showing the LCD Pixel Switch Gate open close matrix part of the mechanism.

FIG. 2D is an illustration representative showing the LCD Pixel Switch Gate open close matrix filter that allows the laser to pass through or not part of the mechanism.

FIG. 2E is an illustration representative showing the mechanical switch gate laser part of the mechanism.

FIG. 2F is an illustration representative showing the mechanical switch gate laser beam part of the mechanism.

FIG. 2G is an illustration representative showing the mechanical switch gate rotating mechanism with holes open or closes part of the mechanism.

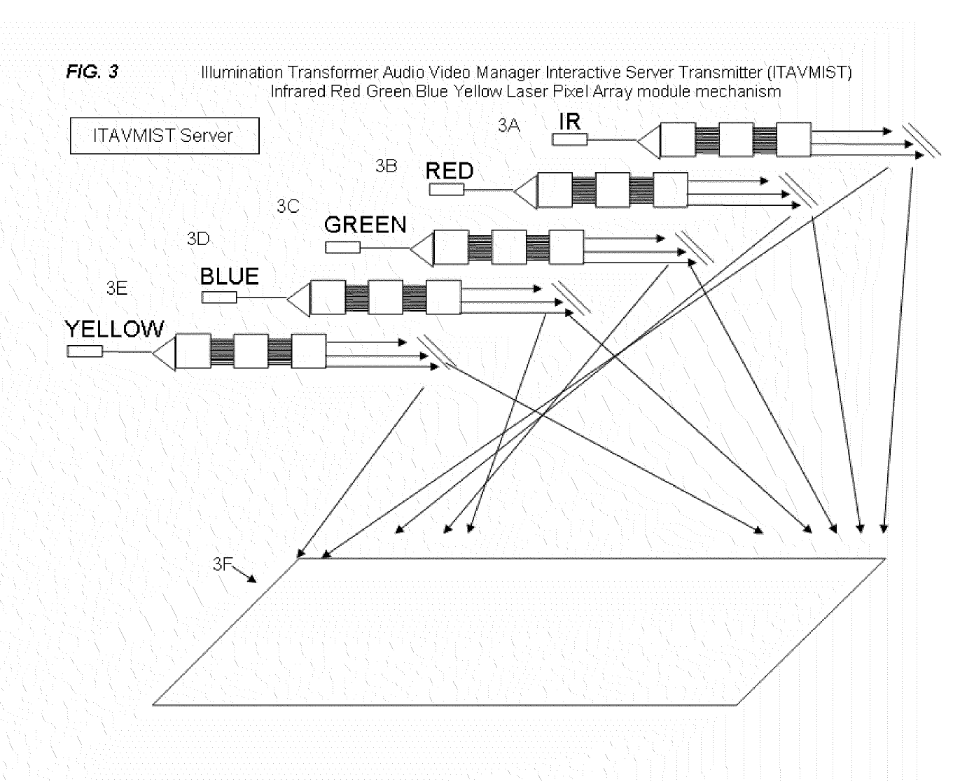

FIG. 3 is a conceptual diagram representative of Illumination Transformer Audio Video Manager Interactive Server Transmitter (ITAVMIST)Infrared Red Green Blue Yellow Laser Pixel Array module mechanism.

FIG. 3A is an illustration representative showing the ITAVMIST infrared light laser part of the mechanism.

FIG. 3B is an illustration representative showing the ITAVMIST Red light laser beam part of the mechanism.

FIG. 3C is an illustration representative showing the ITAVMIST Green light laser part of the mechanism.

FIG. 3D is an illustration representative showing the ITAVMIST Blue light laser beam part of the mechanism.

FIG. 3E is an illustration representative showing the ITAVMIST Yellow light laser part of the mechanism.

FIG. 3F is an illustration representative showing the ITAVMIST laser beam free space intersection points pixel target part of the mechanism.

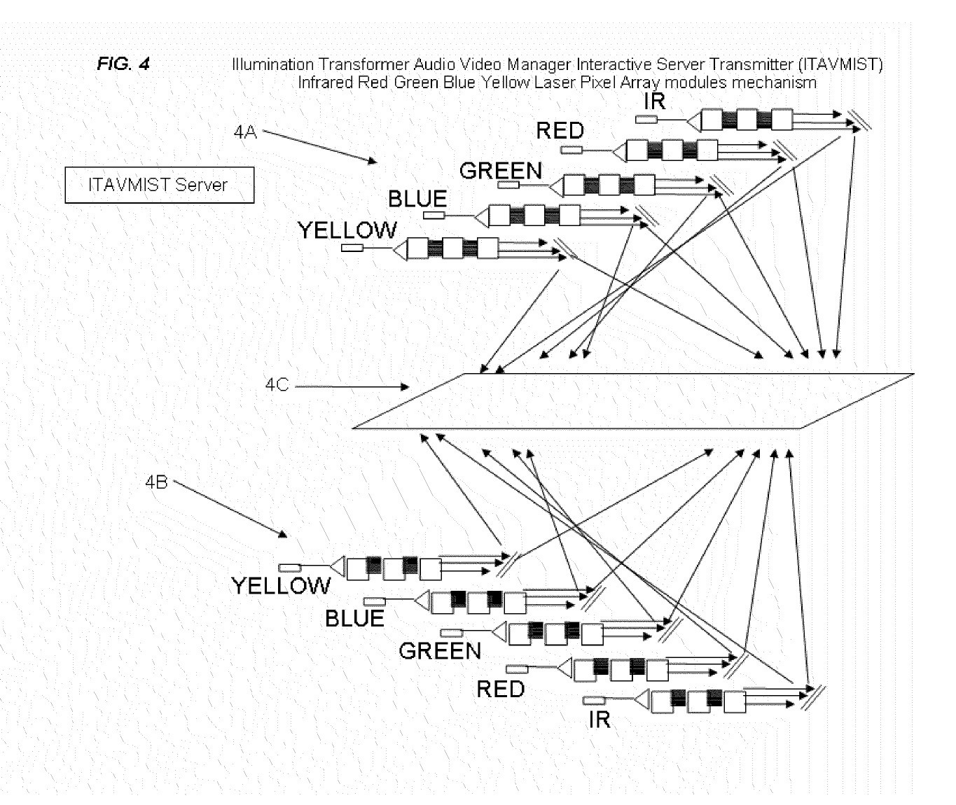

FIG. 4 is a conceptual diagram representative of Illumination Transformer Audio Video Manager Interactive Server Transmitter (ITAVMIST) Infrared Red Green Blue Yellow Laser Pixel Array modules mechanism.

FIG. 4A is an illustration representative showing the Infrared Red Green Blue Yellow Laser Pixel Array modules mechanism one part of the mechanism.

FIG. 4B is an illustration representative showing the Infrared Red Green Blue Yellow Laser Pixel Array modules mechanism two part of the mechanism.

FIG. 4C is an illustration representative showing the ITAVMIST laser beam free space intersection points pixel target part of the mechanism.

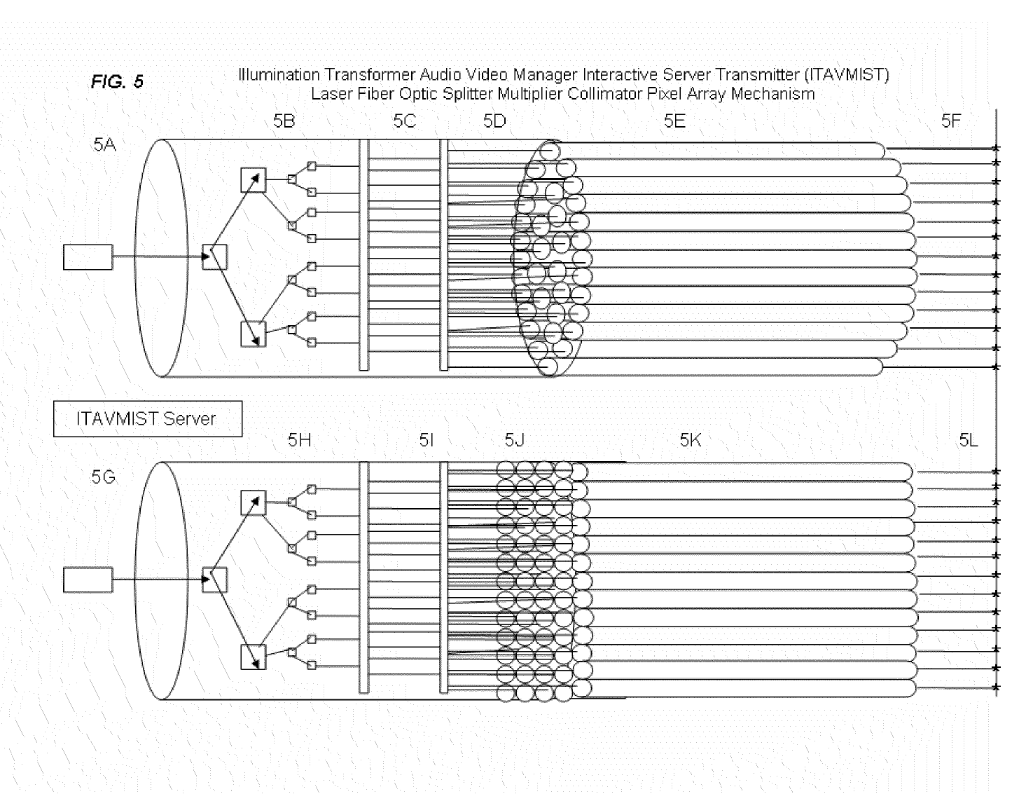

FIG. 5 is a conceptual diagram representative of Illumination Transformer Audio Video Manager Interactive Server Transmitter (ITAVMIST) Laser Fiber Optic Splitter Multiplier Collimator Pixel Array Mechanism.

FIG. 5A is an illustration representative showing the laser diode beam part of the mechanism.

FIG. 5B is an illustration representative showing the infrared laser beam splitter crystals for multiple splitting of beams part of the mechanism.

FIG. 5C is an illustration representative showing the second infrared laser beam splitter crystals for again multiple splitting of beams part of the mechanism.

FIG. 5D is an illustration representative showing the third infrared laser beam splitter crystals for still again multiple splitting of beams part of the mechanism.

FIG. 5E is an illustration representative showing the laser round array fiber optic collimator apparatus part of the mechanism.

FIG. 5F is an illustration representative showing the multiple round pattern array laser beam projection part of the mechanism.

FIG. 5G is an illustration representative showing the laser diode beam part of the mechanism.

FIG. 5H is an illustration representative showing the infrared laser beam splitter crystals for multiple splitting of beams part of the mechanism.

FIG. 5I is an illustration representative showing the second infrared laser beam splitter crystals for again multiple splitting of beams part of the mechanism.

FIG. 5J is an illustration representative showing the third infrared laser beam splitter crystals for still again multiple splitting of beams part of the mechanism.

FIG. 5K is an illustration representative showing the laser square array fiber optic collimator apparatus part of the mechanism.

FIG. 5L is an illustration representative showing the multiple square pattern array laser beam projection part of the mechanism.

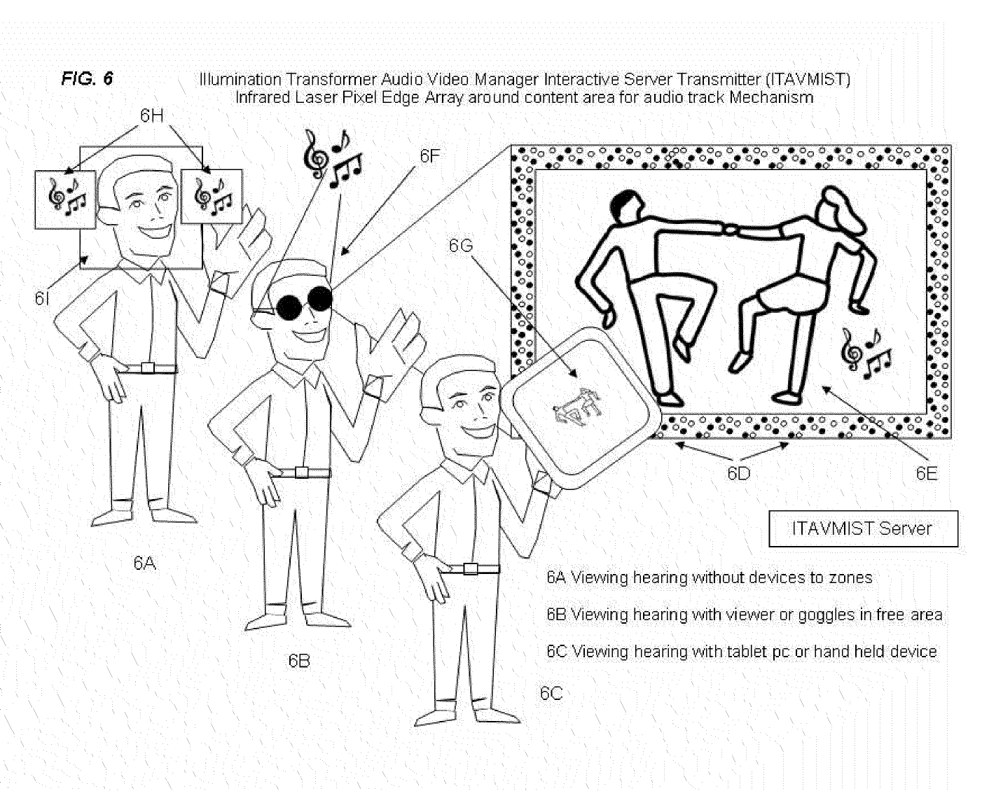

FIG. 6 is a conceptual diagram representative of Illumination Transformer Audio Video Manager Interactive Server Transmitter (ITAVMIST) Infrared Laser Pixel Array intersection points with 2 lasers mechanism.

FIG. 6A is an illustration representative showing how a user can view with out any device the content projected in free space part of the mechanism.

FIG. 6B is an illustration representative showing how a user can view with viewing device the content projected in free space part of the mechanism.

FIG. 6C is an illustration representative showing the how a user can view with computer tablet or hand held device, the content projected in free space part of the mechanism.

FIG. 6D is an illustration representative showing the infrared light laser intersection point binaural stereo sound track part of the mechanism.

FIG. 6E is an illustration representative showing the content projected in free space with the infrared audio track around it part of the mechanism.

FIG. 6F is an illustration representative showing a person using glasses to view and hear content projected in free space part of the mechanism.

FIG. 6G is an illustration representative showing a person using a tablet PC or hand held device to view and hear content projected in free space part of the mechanism.

FIG. 6H is an illustration representative showing the audio zone spatial point targeted area for listening part of the mechanism.

FIG. 6I is an illustration representative showing the facial tracking mechanism area for the shutoff security apparatus part of the mechanism.

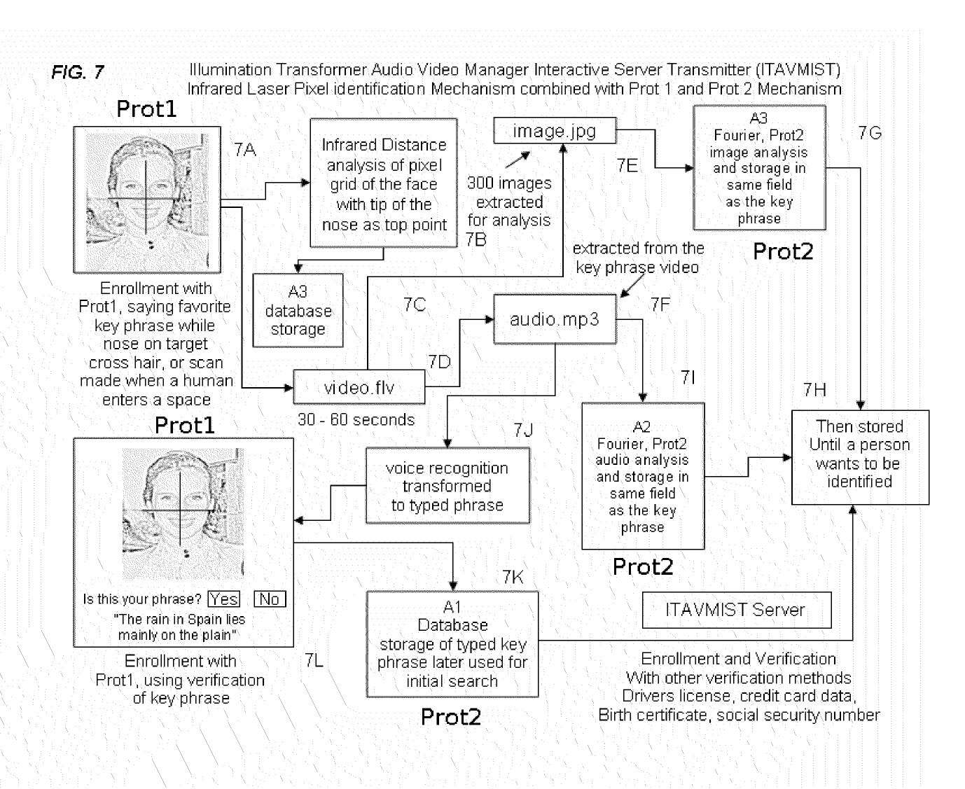

FIG. 7 is a conceptual diagram representative of Illumination Transformer Audio Video Manager Interactive Server Transmitter (ITAVMIST) Infrared Laser Pixel identification mechanism combined with Prot 1 security and Prot 2 security identification mechanism.

FIG. 7A is an illustration representative showing the Enrollment with Prot1, saying favorite key phrase while nose on target cross hair, or scan made when a human enters a space part of the mechanism.

FIG. 7B is an illustration representative showing the Infrared distance analysis of pixel grid of the face with tip of the nose part of the mechanism.

FIG. 7C is an illustration representative showing the infrared distance analysis A3 database storage part of the mechanism.

FIG. 7D is an illustration representative showing the Prot 1 component converting recording into video.flv file part of the mechanism.

FIG. 7E is an illustration representative showing where the system creates 300 images extracted for analysis part of the mechanism.

FIG. 7F is an illustration representative showing the extracted audio file from the key phrase video recorded part of the mechanism.

FIG. 7G is an illustration representative showing the Prot2 storage mechanism A3 Fourier, Prot2 image analysis and storage in same field as the key phrase part of the mechanism.

FIG. 7H is an illustration representative showing the image is then stored by Prot2 until a person wants to be identified part of the mechanism.

FIG. 7I is an illustration representative showing the audio file extracted is stored with A2 Fourier, Prot2 audio analysis and storage in same field as the key phrase part of the mechanism.

FIG. 7J is an illustration representative showing the enrollment or sign in voice recognition is transformed to typed phrase part of the mechanism.

FIG. 7K is an illustration representative showing the typed phrase is recognized and stored by Prot2 in A1 Database storage of typed key phrase later used for initial search part of the mechanism.

FIG. 7L is an illustration representative showing the Enrollment with Prot1, using verification of key phrase part of the mechanism.

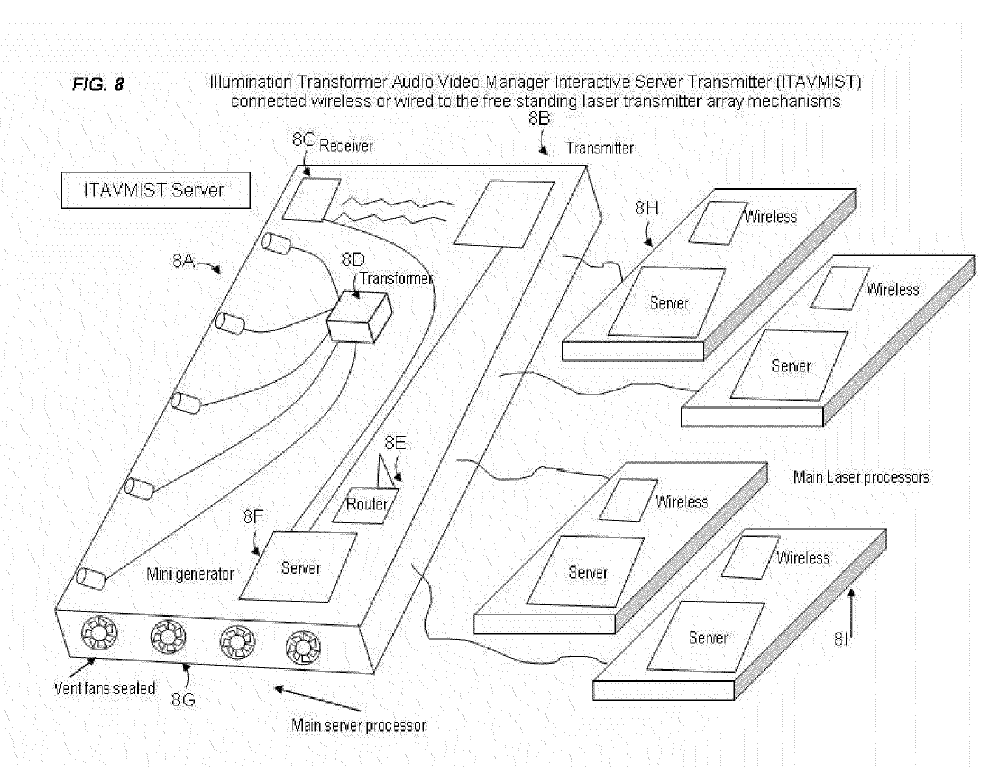

FIG. 8 is a conceptual diagram representative of Illumination Transformer Audio Video Manager Interactive Server Transmitter (ITAVMIST) connected wireless or wired to the free standing laser transmitter array mechanisms.

FIG. 8A is an illustration representative showing the Illumination Transformer Audio Video Manager Interactive Server Transmitter (ITAVMIST) part of the mechanism.

FIG. 8B is an illustration representative showing the wireless energy transmitter part of the mechanism.

FIG. 8C is an illustration representative showing the wireless energy receiver part of the mechanism.

FIG. 8D is an illustration representative showing the transformer mechanism attached to the multiple alternative generators part of the mechanism.

FIG. 8E is an illustration representative showing the computer wireless router part of the mechanism.

FIG. 8F is an illustration representative showing the main server motherboard part of the mechanism.

FIG. 8G is an illustration representative showing the sealed vent fans part of the mechanism.

FIG. 8H is an illustration representative showing the infrared light laser beam server apparatus with wired or wireless energy part of the mechanism.

FIG. 8I is an illustration representative showing the infrared light laser beam server apparatus projection into free space side of the mechanism.

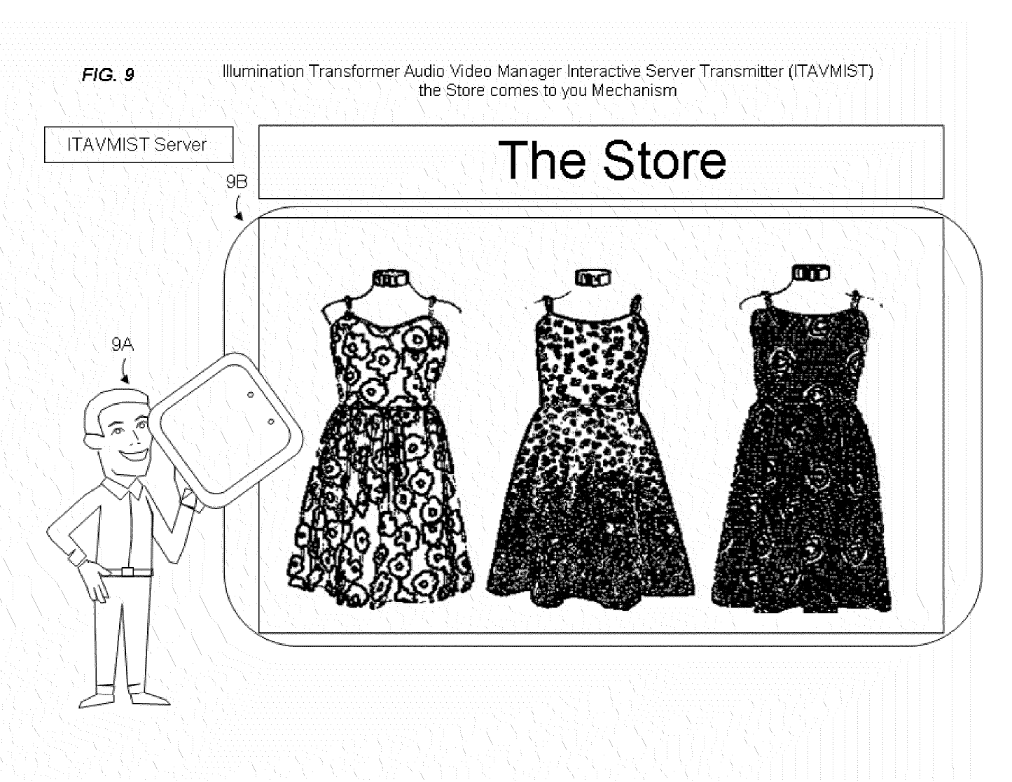

FIG. 9 is a conceptual diagram representative of Illumination Transformer Audio Video Manager Interactive Server Transmitter (ITAVMIST) the store comes to you mechanism.

FIG. 9A is an illustration representative showing the user with tablet PC hand held or no device free space viewing of store at any space managed by the apparatus part of the mechanism.

FIG. 9B is an illustration representative showing the store being projected in free space, for viewing and listening part of the mechanism.

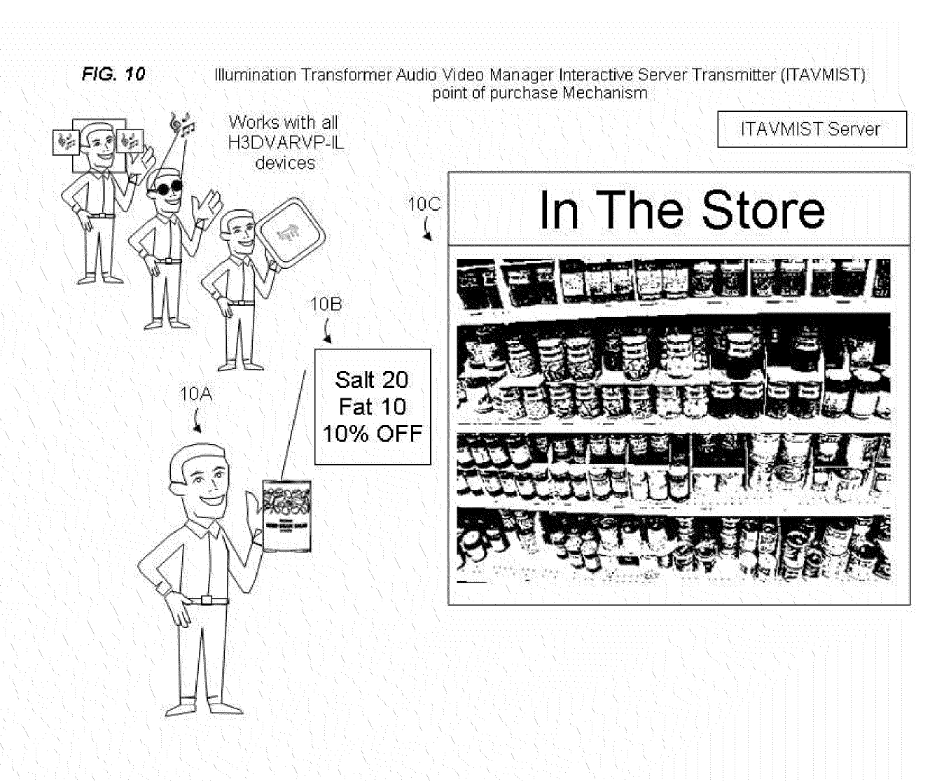

FIG. 10 is a conceptual diagram representative of Illumination Transformer Audio Video Manager Interactive Server Transmitter (ITAVMIST) point of purchase mechanism.

FIG. 10A is an illustration representative showing the user pulling something from the shelf in a store or any place part of the mechanism.

FIG. 10B is an illustration representative showing the free space projection of information or advertising about that item pulled from shelf part of the mechanism.

FIG. 10C is an illustration representative showing the store to you, or you are in the store and you can touch the product or touch the free space projection and the advertising or information comes up in free space with sound or video, or images part of the mechanism.

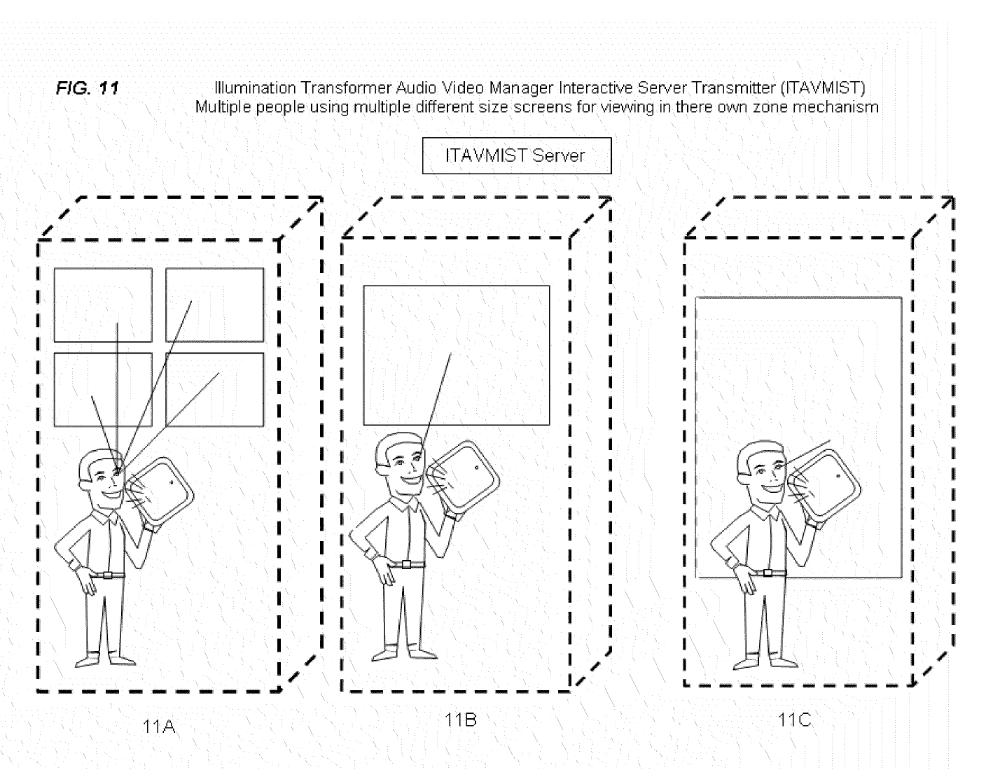

FIG. 11 is a conceptual diagram representative of Illumination Transformer Audio Video Manager Interactive Server Transmitter (ITAVMIST) Multiple people using multiple different size screens for viewing in there own zone mechanism.

FIG. 11A is an illustration representative showing a person viewing 4 projected screens in a private space zone next 2 other people part of the mechanism.

FIG. 11B is an illustration representative showing a person viewing a frontal single screen next to other people in a zone part of the mechanism.

FIG. 11C is an illustration representative showing a person who has re sized his screen in his zone next to other people viewing in their zones part of the mechanism.

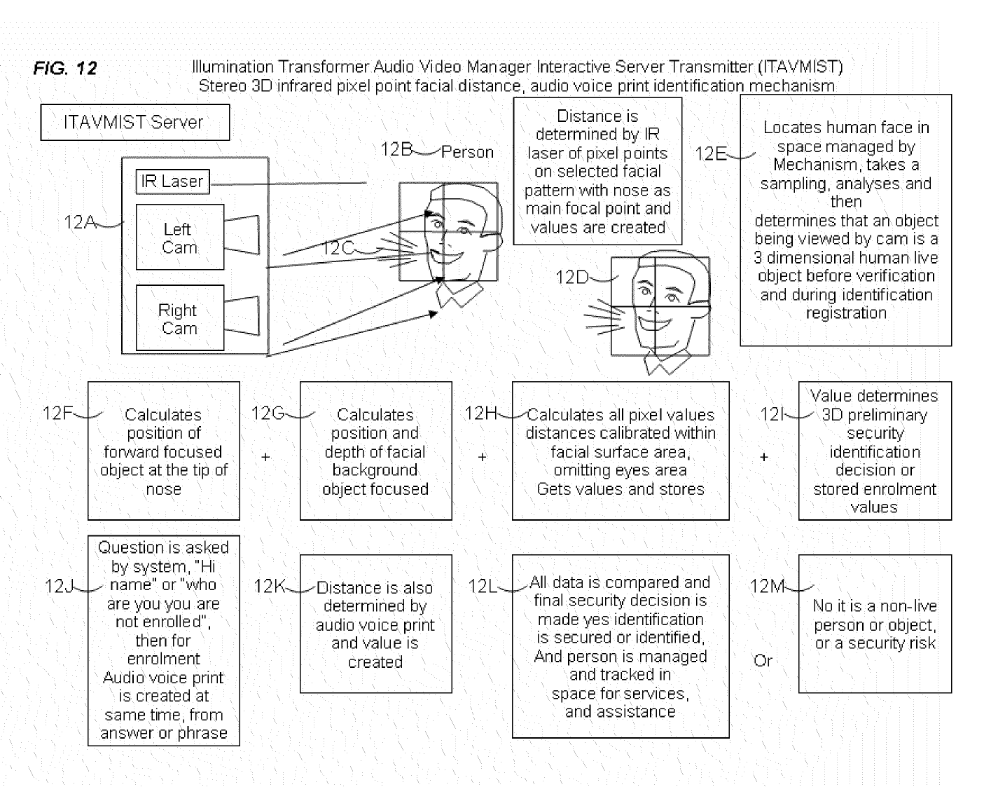

FIG. 12 is a conceptual diagram representative of Illumination Transformer Audio Video Manager Interactive Server Transmitter (ITAVMIST) Stereo 3D infrared pixel point facial distance, audio voice print identification mechanism.

FIG. 12A is an illustration representative showing the infrared light laser left cam and right cam part of the mechanism.

FIG. 12B is an illustration representative showing a person being identified as part of the mechanism.

FIG. 12C is an illustration representative showing the person speaking a phrase as part of the mechanism.

FIG. 12D is an illustration representative showing where the Distance is instantly determined by IR laser of pixel points on selected facial pattern with nose as main focal point and values are created part of the mechanism.

FIG. 12E is an illustration representative showing where the system locates human face in space managed by mechanism, takes a sampling, analyzes and then determines that an object being viewed by cam is a 3 dimensional human live object before verification and during identification registration part of the mechanism.

FIG. 12F is an illustration representative showing where system Calculates position of forward focused object at the tip of nose part of the mechanism.

FIG. 12G is an illustration representative showing system that Calculates position and depth of facial background object focused part of the mechanism.

FIG. 12H is an illustration representative showing where the system calculates all pixel values distances calibrated with in facial surface area, omitting eyes area gets values and stores part of the mechanism.

FIG. 12I is an illustration representative showing where the created Value determines 3D preliminary security identification decision or stored enrollment values part of the mechanism.

FIG. 12J is an illustration representative showing a Question is asked by system, “Hi name” or “who are you are not enrolled”, then for enrollment Audio voice print is created at same time, from answer or phrase part of the mechanism.

FIG. 12K is an illustration representative showing where the Distance is also determined by audio voice print and value is created by the system part of the mechanism.

FIG. 12L is an illustration representative showing that in the system All data is compared and final security decision is made yes identification is secured or identified, and person is managed and tracked in space for services, and assistance part of the mechanism.

FIG. 12M is an illustration representative showing the or No it is a non-live person or object, or a security risk system response part of the mechanism.

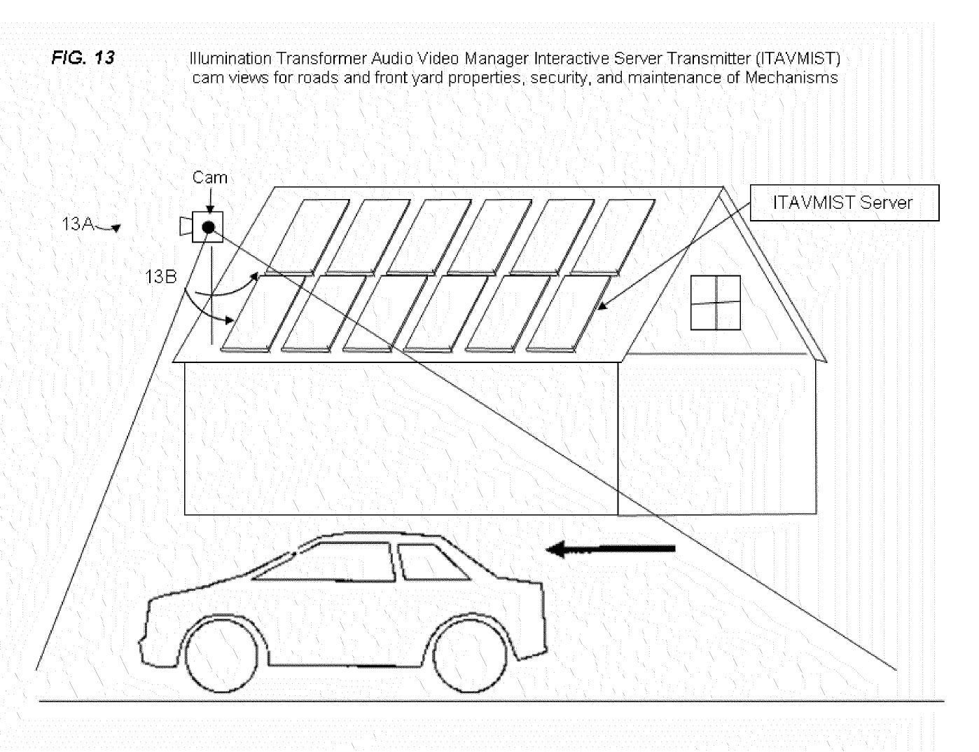

FIG. 13 is a conceptual diagram representative of Illumination Transformer Audio Video Manager Interactive Server Transmitter (ITAVMIST) cam views for roads and front yard properties, security, and maintenance of Mechanisms mechanism.

FIG. 13A is an illustration representative showing the infrared light security and maintenance cam part of the mechanism.

FIG. 13B is an illustration representative showing the parallel coupled multiple Illumination Transformer Audio Video Manager Interactive Server Transmitter (ITAVMIST) with solar energy servers as part of the mechanism.

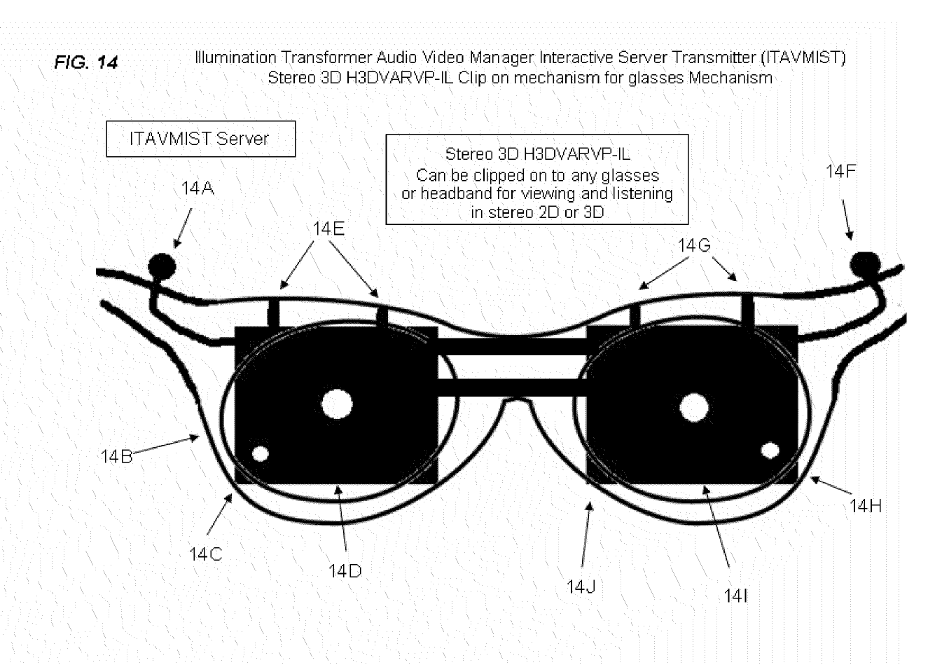

FIG. 14 is a conceptual diagram representative of Illumination Transformer Audio Video Manager Interactive Server Transmitter (ITAVMIST) Stereo 3D H3DVARVP-IL Clip on mechanism for glasses mechanism.

FIG. 14A is an illustration representative showing the Stereo 3D H3DVARVP-IL Can be clipped on to any glasses or headband for viewing and listening in stereo 2D or 3D right user speaker part of the mechanism.

FIG. 14B is an illustration representative showing the Stereo 3D H3DVARVP-IL Can be clipped on to any glasses or headband for viewing and listening in stereo 2D or 3D right component clip on screen part of the mechanism.

FIG. 14C is an illustration representative showing the Stereo 3D H3DVARVP-IL Can be clipped on to any glasses or headband for viewing and listening in stereo 2D or 3D right microphone part of the mechanism.

FIG. 14D is an illustration representative showing the Stereo 3D H3DVARVP-IL Can be clipped on to any glasses or headband for viewing and listening in stereo 2D or 3D right screen center cam part of the mechanism.

FIG. 14E is an illustration representative showing the Stereo 3D H3DVARVP-IL Can be clipped on to any glasses or headband for viewing and listening in stereo 2D or 3D right screen hold on clips part of the mechanism.

FIG. 14F is an illustration representative showing the Stereo 3D H3DVARVP-IL Can be clipped on to any glasses or headband for viewing and listening in stereo 2D or 3D left speaker part of the mechanism.

FIG. 14G is an illustration representative showing the Stereo 3D H3DVARVP-IL Can be clipped on to any glasses or headband for viewing and listening in stereo 2D or 3D left screen clip on unit part of the mechanism.

FIG. 14H is an illustration representative showing the Stereo 3D H3DVARVP-IL Can be clipped on to any glasses or headband for viewing and listening in stereo 2D or 3D left microphone part of the mechanism.

FIG. 14I is an illustration representative showing the Stereo 3D H3DVARVP-IL Can be clipped on to any glasses or headband for viewing and listening in stereo 2D or 3D left screen center cam part of the mechanism.

FIG. 14J is an illustration representative showing the Stereo 3D H3DVARVP-IL Can be clipped on to any glasses or headband for viewing and listening in stereo 2D or 3D left screen part of the mechanism.

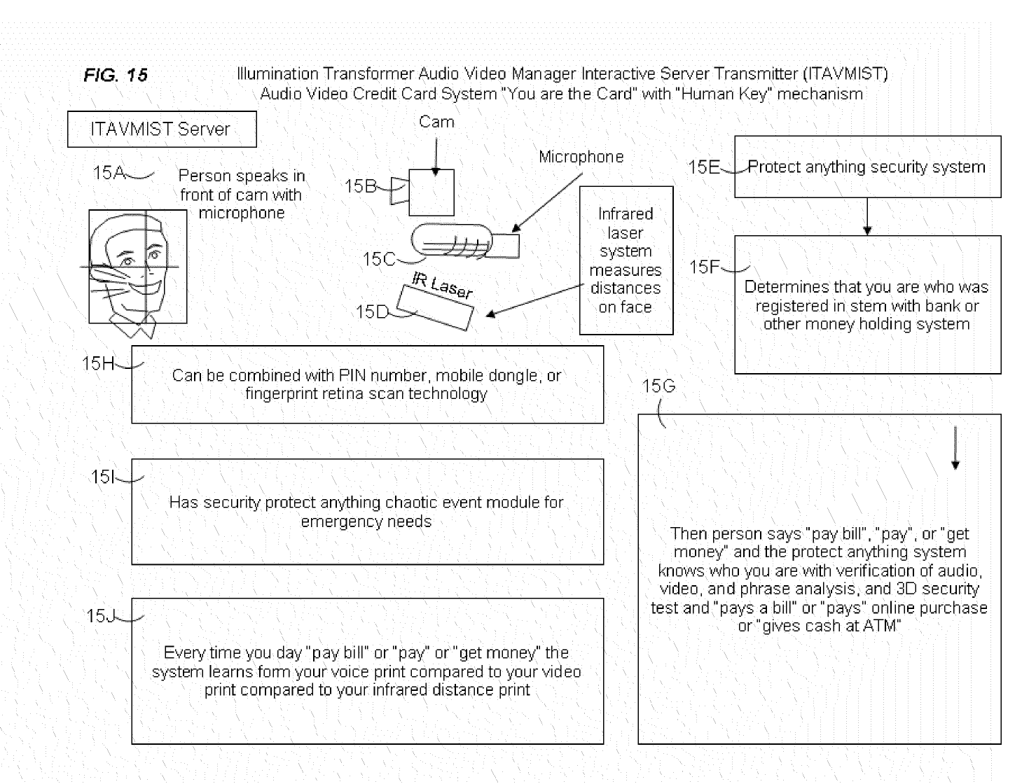

FIG. 15 is a conceptual diagram representative of Illumination Transformer Audio Video Manager Interactive Server Transmitter (ITAVMIST) Audio Video Credit Card System “You are the Card” with “Human Key” mechanism.

FIG. 15A is an illustration representative showing the Person speaks in front of cam with microphone part of the mechanism.

FIG. 15B is an illustration representative showing the identification cam or cams part of the mechanism.

FIG. 15C is an illustration representative showing the identification microphone or microphones part of the mechanism.

FIG. 15D is an illustration representative showing the identification infrared laser system which measures distances on face part of the mechanism.

FIG. 15E is an illustration representative showing the Protect anything security system part of the mechanism.

FIG. 15F is an illustration representative showing the system that Determines that you are who was registered in stem with bank or other money holding system part of the mechanism.

FIG. 15G is an illustration representative showing where Then a person says “pay bill”, “pay”, or “get money” and the protect anything system knows who you are with verification of audio, video, and phrase analysis, and 3D security test and “pays a bill” or “pays” online purchase or “gives cash at ATM” part of the mechanism.

FIG. 15H is an illustration representative showing the mechanism method Can be combined with PIN number, mobile dongle, or fingerprint retina scan technology part of the mechanism.

FIG. 15I is an illustration representative showing the system has security protect anything chaotic event module for emergency needs as part of the mechanism.

FIG. 15J is an illustration representative showing where Every time you say “pay bill” or “pay” or “get money” the system learns form your voice print compared to your video print compared to your infrared distance print part of the mechanism.

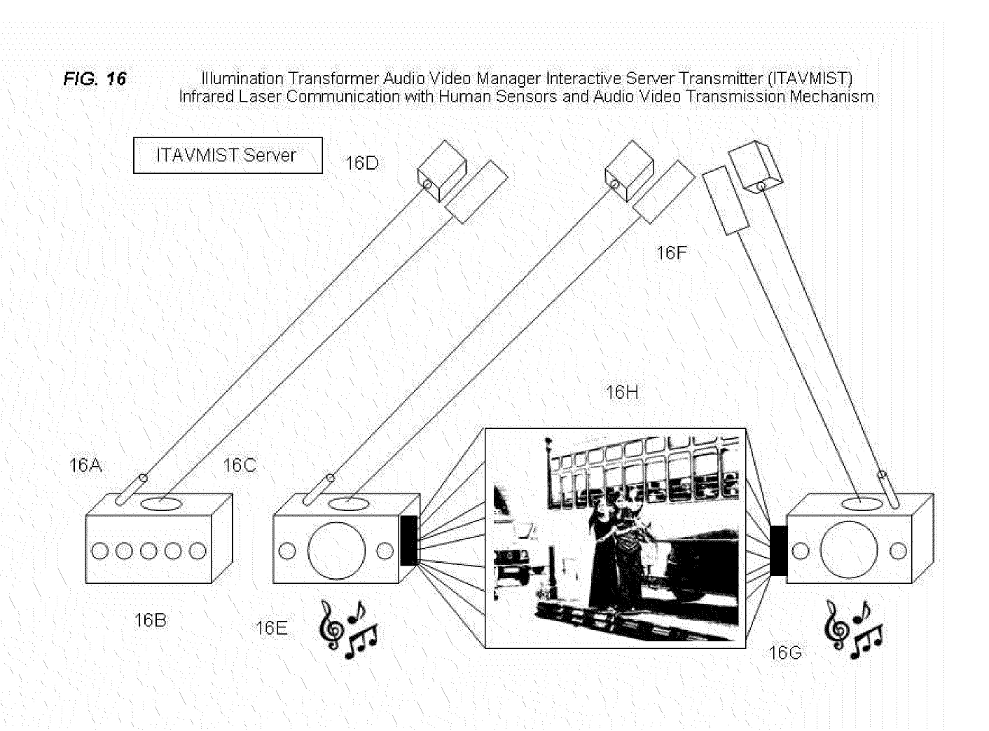

FIG. 16 is a conceptual diagram representative of Illumination Transformer Audio Video Manager Interactive Server Transmitter (ITAVMIST) Infrared Laser Communication with Human Sensors and Audio Video Transmission Mechanism.

FIG. 16A is an illustration representative showing where information is transmitted by laser to the Illumination Transformer Audio Video Manager Interactive Server Transmitter (ITAVMIST) apparatus as part of the mechanism.

FIG. 16B is an illustration representative showing where information from all five senses taste, touch, smell, vision and hearing can be transmitted or received and projected as part of the mechanism.

FIG. 16C is an illustration representative showing where information is received by laser from the Illumination Transformer Audio Video Manager Interactive Server Transmitter (ITAVMIST) apparatus as part of the mechanism.

FIG. 16D is an illustration representative showing where information is transmitted by laser from the Illumination Transformer Audio Video Manager Interactive Server Transmitter (ITAVMIST) apparatus as part of the mechanism.

FIG. 16E is an illustration representative showing the infrared light laser right speaker part of the mechanism.

FIG. 16F is an illustration representative showing where information is transmitted by laser from the Illumination Transformer Audio Video Manager Interactive Server Transmitter (ITAVMIST) apparatus to entertainment unit as part of the mechanism.

FIG. 16G is an illustration representative showing the infrared light laser left speaker part of the mechanism.

FIG. 16H is an illustration representative showing the projected free space content part of the mechanism.

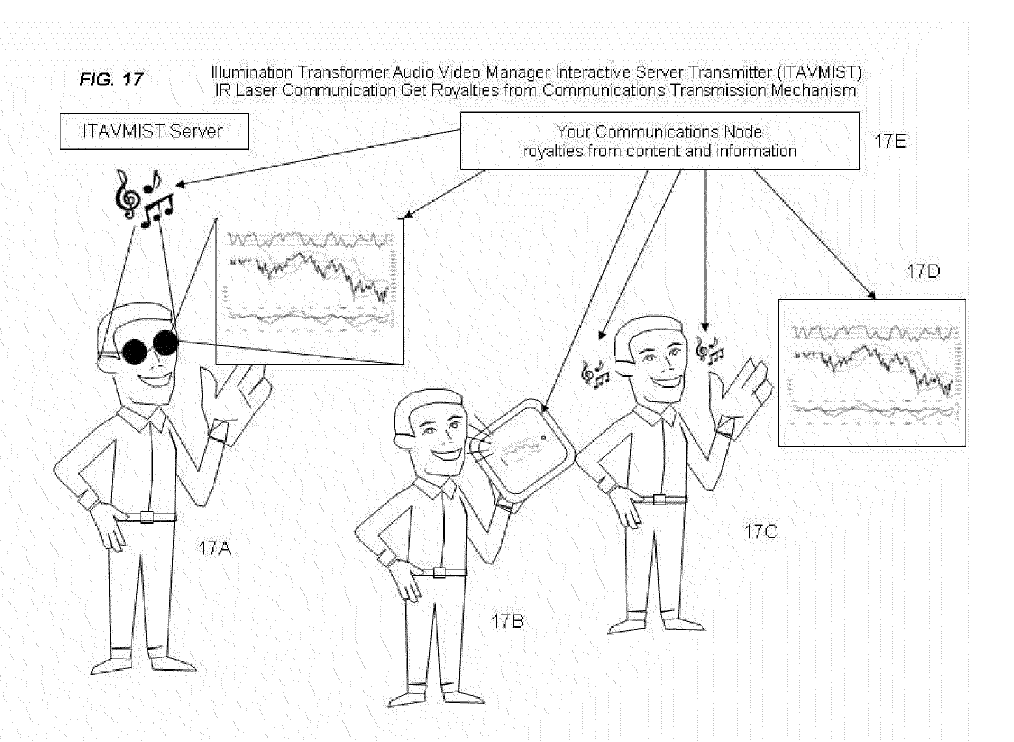

FIG. 17 is a conceptual diagram representative of Illumination Transformer Audio Video Manager Interactive Server Transmitter (ITAVMIST) IR Laser Communication Get Royalties from Communications Transmission Mechanism.

FIG. 17A is an illustration representative showing a person using viewing glasses to view chart part of the mechanism.

FIG. 17B is an illustration representative showing a person using a hand held device or tablet PC to view chart part of the mechanism.

FIG. 17C is an illustration representative showing a person using no device to view chart part of the mechanism.

FIG. 17D is an illustration representative showing the projected chart content in free space part of the mechanism.

FIG. 17E is an illustration representative showing your communications node royalties from content and information projected to you part of the mechanism.

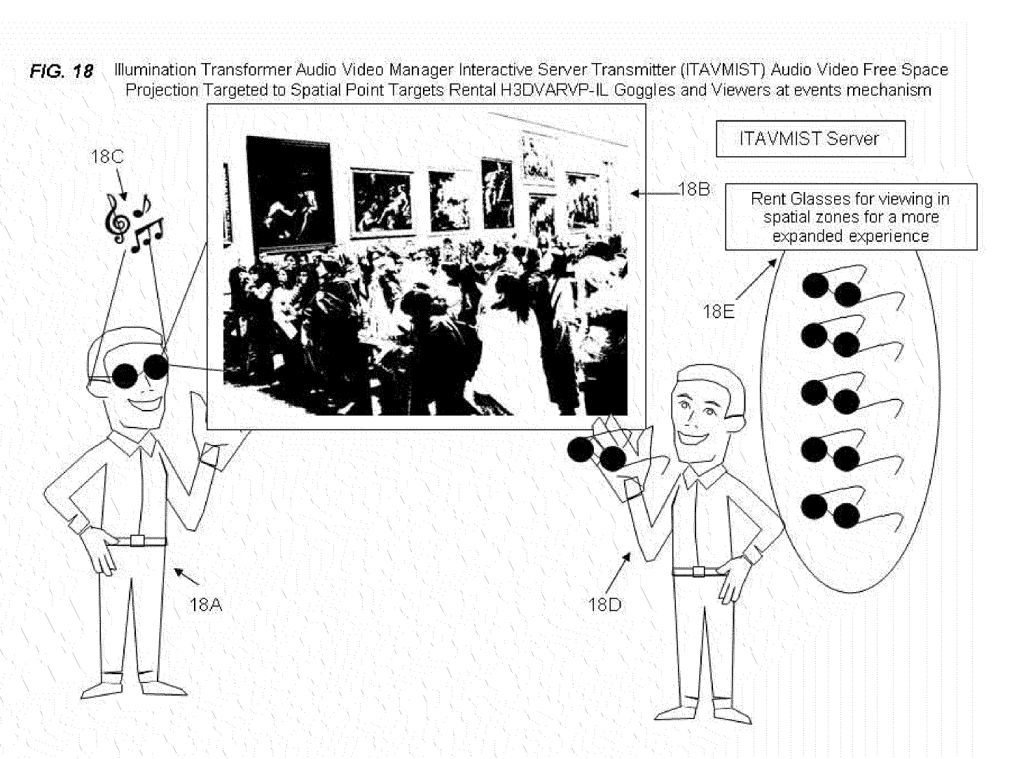

FIG. 18 is a conceptual diagram representative of Illumination Transformer Audio Video Manager Interactive Server Transmitter (ITAVMIST) Free Space Projection Targeted to Spatial Point Targets Rental H3DVARVP-IL Goggles and Viewers at events mechanism.

FIG. 18A is an illustration representative showing user viewing and listening to content with rented glasses apparatus as part of the mechanism.

FIG. 18B is an illustration representative showing projected free space image content part of the mechanism.

FIG. 18C is an illustration representative showing projected free space audio content part of the mechanism.

FIG. 18D is an illustration representative showing person renting free space glasses viewing apparatus part of the mechanism.

FIG. 18E is an illustration representative showing the Rent Glasses for viewing in spatial zones for a more expanded experience as part of the mechanism.

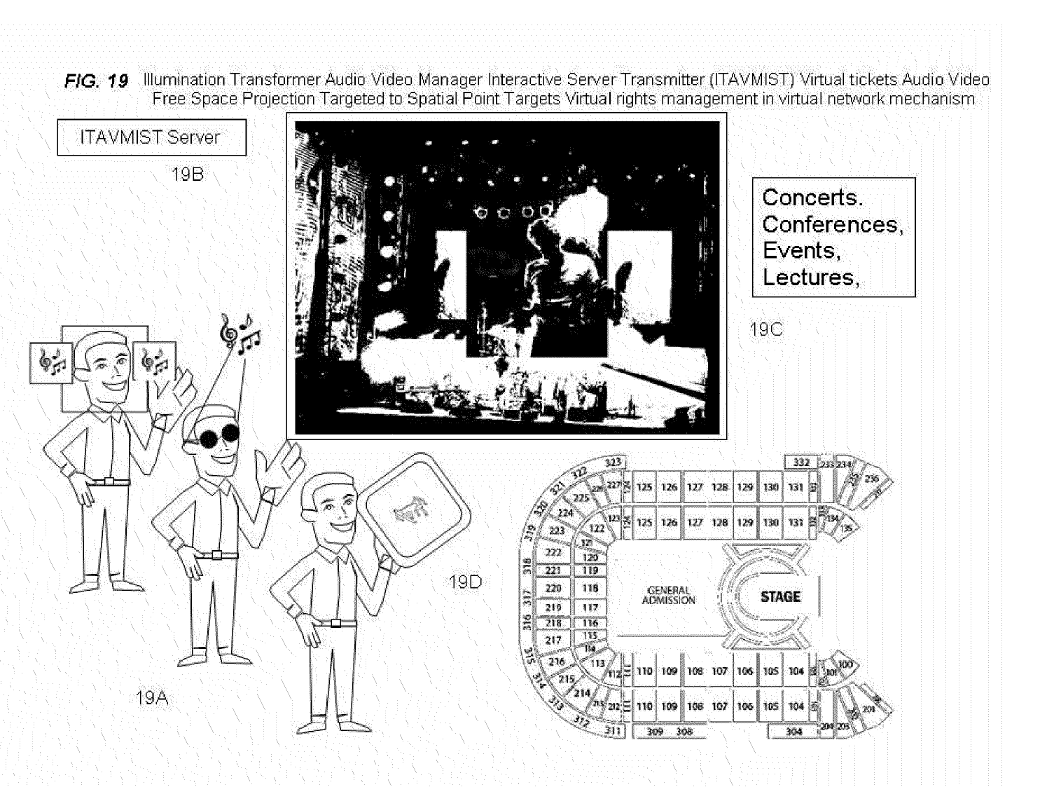

FIG. 19 is a conceptual diagram representative of Illumination Transformer Audio Video Manager Interactive Server Transmitter (ITAVMIST) Audio Video Free Space Projection Targeted to Spatial Point Targets Virtual rights management in virtual network mechanism.

FIG. 19A is an illustration representative showing user watching virtual concert or entertainment at show or at home part of the mechanism.

FIG. 19B is an illustration representative showing audio content projected to user part of the mechanism.

FIG. 19C is an illustration representative showing the images or video projected in free space to user from Concerts, Conferences, Events, Lectures, part of the mechanism.

FIG. 19D is an illustration representative showing where user can choose which seat they want to view from in venue location, and have it projected to their location at venue or to their home or any space part of the mechanism.

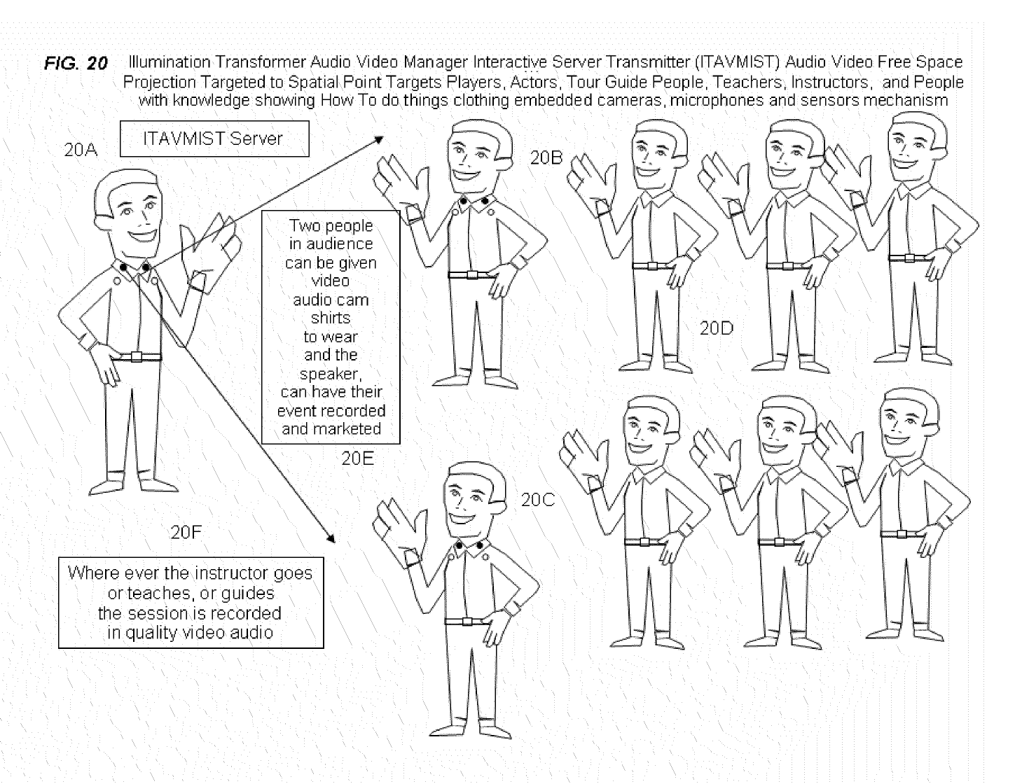

FIG. 20 is a conceptual diagram representative of Illumination Transformer Audio Video Manager Interactive Server Transmitter (ITAVMIST) Free Space Projection Targeted to Spatial Point Targets Players, Actors, Tour Guide People, Teachers, Instructors, and People with knowledge showing How To do things clothing embedded cameras, microphones and sensors mechanism.

FIG. 20A is an illustration representative showing instructor, actor, sports person performing and recording in 3D Video and 3D Stereo from embedded cameras and microphones in his clothing part of the mechanism.

FIG. 20B is an illustration representative showing the left camera person wearing camera microphone embedded clothing part of the mechanism.

FIG. 20C is an illustration representative showing the right camera person wearing camera microphone embedded clothing part of the mechanism.

FIG. 20D is an illustration representative showing group of people or students watching lecture, as the 2 people are recording from embedded clothing camera microphone apparatus part of the mechanism.

FIG. 20E is an illustration representative showing where two people in audience can be given video audio cam shirts to wear and the speaker, can have their event recorded and marketed part of the mechanism.

FIG. 20F is an illustration representative showing where ever the instructor goes or teaches, or guides the session is recorded in quality video audio part of the mechanism.

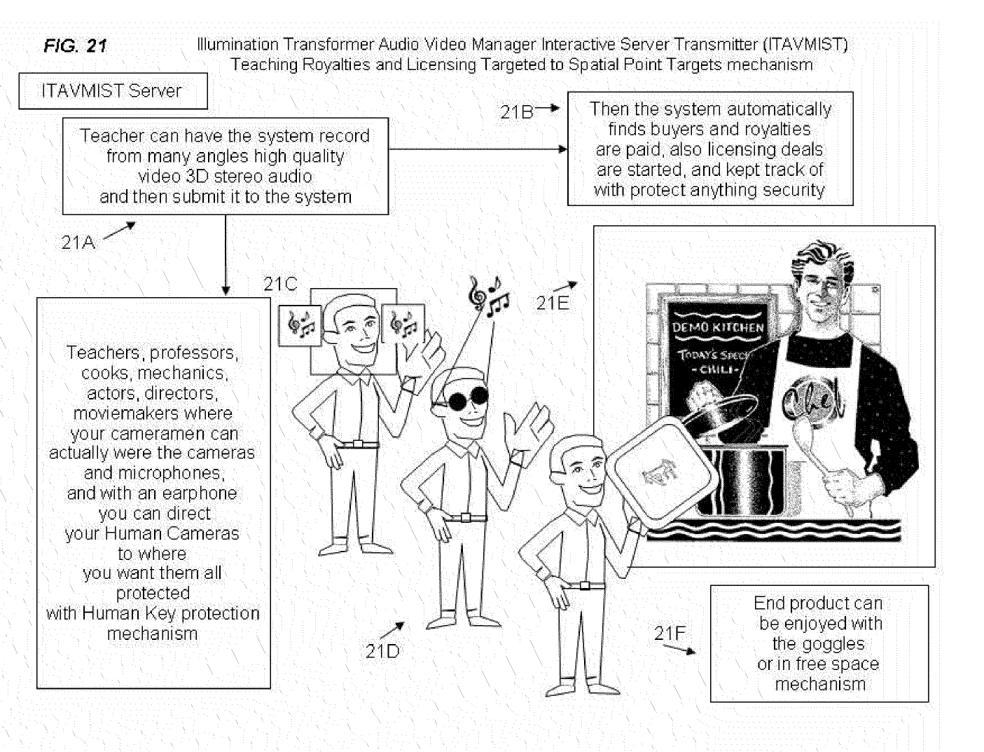

FIG. 21 is a conceptual diagram representative of Illumination Transformer Audio Video Manager Interactive Server Transmitter (ITAVMIST) Teaching Royalties and Licensing Targeted to Spatial Point Targets mechanism.

FIG. 21A is an illustration representative showing where the Teacher can have the system record from many angles high quality video 3D stereo audio and then submit it to the system part of the mechanism.

FIG. 21B is an illustration representative showing where Then the system automatically finds buyers and royalties are paid, also licensing deals are started, and kept track of with protect anything security part of the mechanism.

FIG. 21C is an illustration representative showing where Teachers, professors, cooks, mechanics, actors, directors, movie makers where your cameramen can actually were the cameras and microphones, and with an earphone you can direct your Human Cameras to where you want them all protected with Human Key protection apparatus part of the mechanism.

FIG. 21D is an illustration representative showing the audio intellectual property projected beam part of the mechanism.

FIG. 21E is an illustration representative showing the image video content intellectual property projected part of the mechanism.

FIG. 21F is an illustration representative showing where end product can be enjoyed with the goggles viewers or in free space apparatus part of the mechanism.

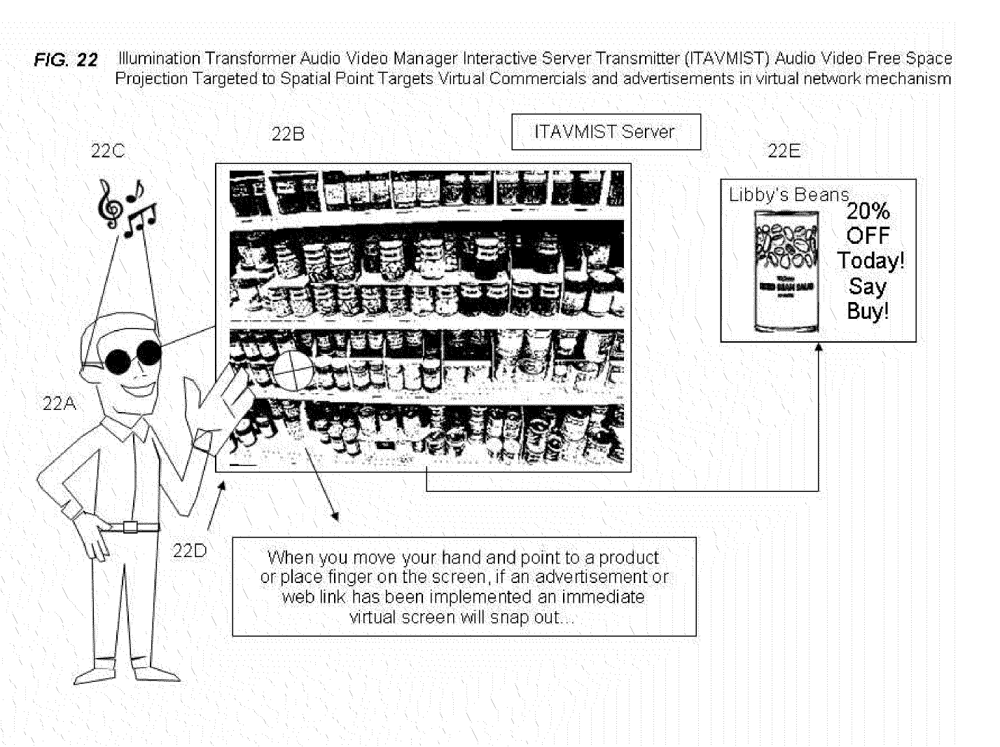

FIG. 22 is a conceptual diagram representative of Illumination Transformer Audio Video Manager Interactive Server Transmitter (ITAVMIST) Free Space Projection Targeted to Spatial Point Targets Virtual Commercials and advertisements in virtual network mechanism.

FIG. 22A is an illustration representative showing the user viewing advertisements from content areas part of the mechanism.

FIG. 22B is an illustration representative showing the image video projection part of the mechanism.

FIG. 22C is an illustration representative showing the audio projection part of the mechanism.

FIG. 22D is an illustration representative showing when you move your hand and point to a product or place finger on the screen, if an advertisement or web link has been implemented an immediate virtual screen will snap out part of the mechanism.

FIG. 22E is an illustration representative showing the out projected advertising message or information after touching screen or products part of the mechanism.

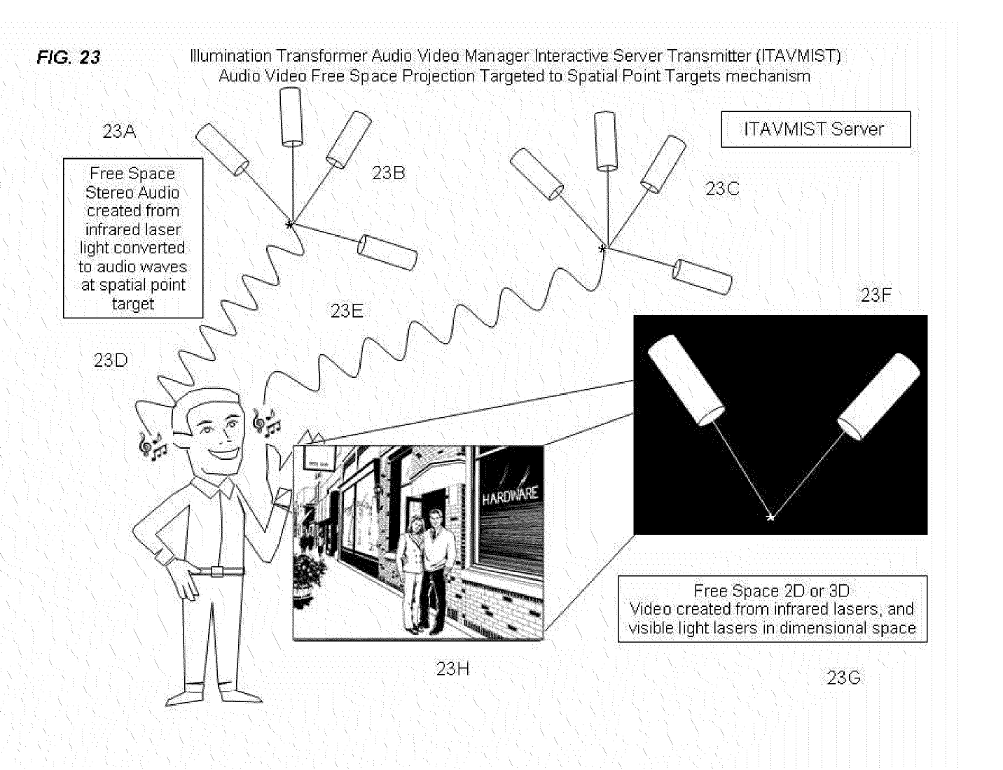

FIG. 23 is a conceptual diagram representative of Illumination Transformer Audio Video Manager Interactive Server Transmitter (ITAVMIST) Audio Video Free Space Projection Targeted to Spatial Point Targets mechanism.

FIG. 23A is an illustration representative showing the Free Space Stereo Audio created from infrared laser light converted to audio waves at spatial point target part of the mechanism.

FIG. 23B is an illustration representative showing the right infrared light laser beams intersecting in a way to create sound waves at a particular spatial point part of the mechanism.

FIG. 23C is an illustration representative showing the left infrared light laser beams intersecting in a way to create sound waves at a particular spatial point part of the mechanism.

FIG. 23D is an illustration representative showing person listening at the right ear spatial point to the projected sound and video part of the mechanism.

FIG. 23E is an illustration representative showing person listening at the left ear spatial point to the projected sound and video part of the mechanism.

FIG. 23F is an illustration representative showing the infrared light laser beams projected to create plasma visible light that can be colored for viewing pixels in free space part of the mechanism.

FIG. 23G is an illustration representative showing the Free Space 2D or 3DVideo created from infrared lasers, and visible light lasers in dimensional space part of the mechanism.

FIG. 23H is an illustration representative showing the infrared and visible light laser beam projected content part of the mechanism.

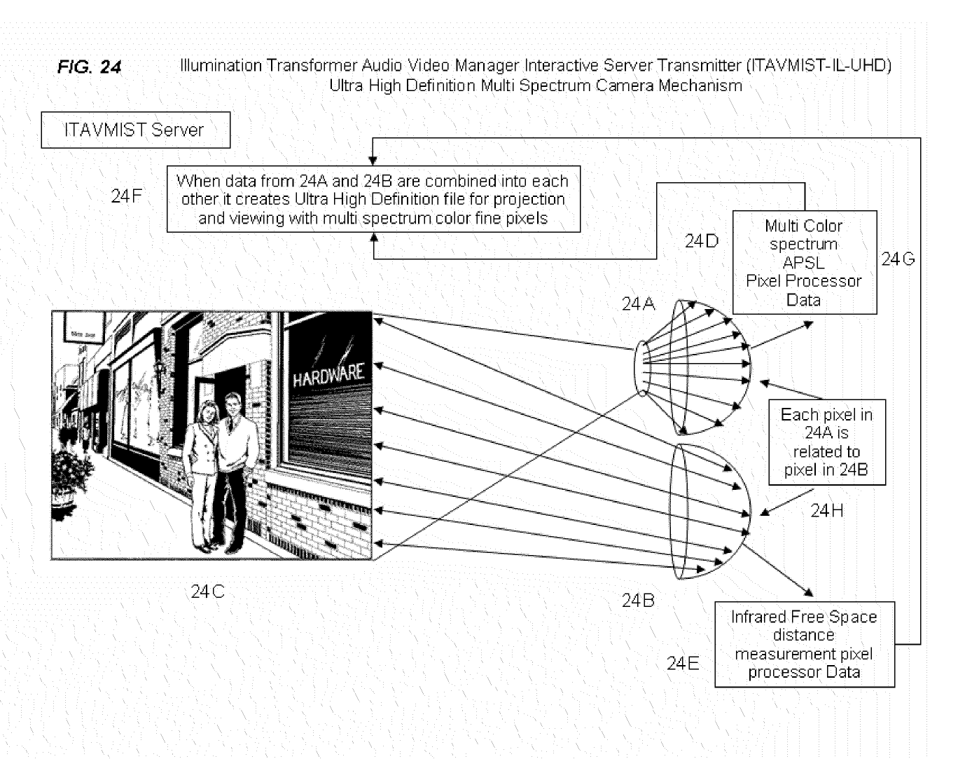

FIG. 24 is an illustration representative showing the Illumination Transformer Audio Video Manager Interactive Server Transmitter (ITAVMIST-IL-UHD) Ultra High Definition Multi Spectrum Camera Mechanism and further comprising a method and mechanism which is an active-pixel sensor (APS) device that includes a plurality of curved bowl shape sensors with active-pixel image sensors that have sensitivity to wide spectral gamut of colors at nano scale each combined with position related active pixel sensor imager (APSI) infrared distance measurement recording mechanism, for recording of distance to the nano pixel object, for processing in determining ultra high resolution vision, and further comprising where distance to object viewed at upper edge of bowl active-pixel image sensor is always the same as the distance to object viewed center lower edge of active-pixel image sensor bowl, for creating and recording ultra high definition images and video.

FIG. 24A is an illustration representative showing the mechanism which is an active-pixel sensor (APS) device that includes a plurality of curved bowl shape sensors with active-pixel image sensors that have sensitivity to wide spectral gamut of colors at nano scale

FIG. 24B is an illustration representative showing the mechanism that is the position related active pixel sensor imager (APSI) infrared distance measurement recording mechanism, for recording of distance to the nano pixel object,

FIG. 24C is an illustration representative showing the object that is being recorded

FIG. 24D is an illustration representative showing the data from the APS color pixel unit and the infrared distance unit being stored as a file in 24F database and file storage

FIG. 24E is an illustration representative showing the Infrared free space distance measurement pixel processor data storage unit.

FIG. 24F is an illustration representative showing the process where when data from 24A and 24B are combined into 24F each other it creates Ultra High Definition file for projection and viewing with multi spectrum color fine pixels.

FIG. 24G is an illustration representative showing the Multi Color 24D spectrum APS Pixel Processor Data storage unit.

FIG. 24H is an illustration representative showing where each pixel in 24A is related to pixel in 24B.

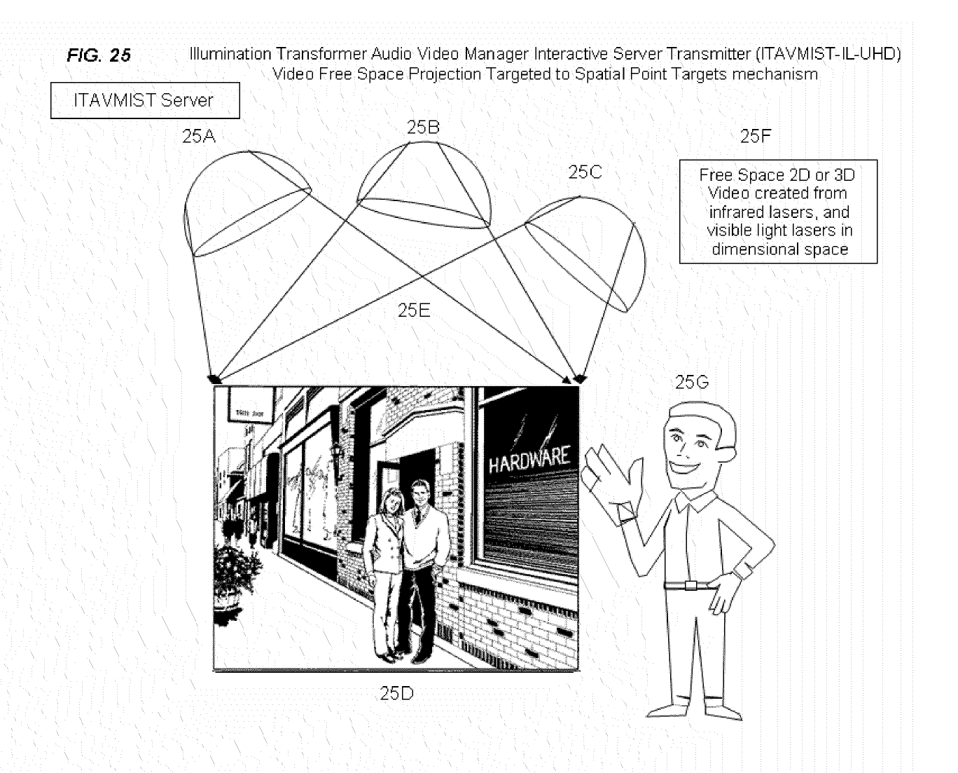

FIG. 25 is an illustration representative showing the Illumination Transformer Audio Video Manager Interactive Server Transmitter (ITAVMIST-IL-UHD) Video Free Space Projection Targeted to Spatial Point Targets mechanism and further comprising a method and mechanism which is an active-pixel sensor laser (APSL) device that includes a plurality of curved bowl shape sensors with active-pixel image lasers that have ability to project wide spectral gamut of colors at nano scale each combined with position related active pixel sensor imager (APSI) infrared distance measurement recording mechanism, for projection of precise distance to the nano pixel object, for projecting in ultra high resolution 2D or 3D images, video, and further comprising where distance to object projected at upper edge of bowl active-pixel image laser is always the same as the distance to object projected to center lower edge of active-pixel image laser bowl, for creating and projecting ultra high definition 2D and 3D images and video to a particular spatial point target, reflected surface or free space projection zone.

FIG. 25A is an illustration representative showing the a position related active pixel sensor imager (APSI) infrared distance measurement recording mechanism, for projection of precise distance to the nano pixel object when synchronized with another identical laser unit then a field 2D, 3D is created in white as a background.

FIG. 25B is an illustration representative showing the mechanism which is an active-pixel sensor laser (APSL) device that includes a plurality of curved bowl shape sensors with active-pixel image lasers that have ability to project wide spectral gamut of colors at nano scale.

FIG. 25C is an illustration representative showing the a position related active pixel sensor imager (APSI) infrared distance measurement recording mechanism, for projection of precise distance to the nano pixel object when synchronized with another identical laser unit then a field 2D, 3D is created in white as a background.

FIG. 25D is an illustration representative showing the projected free space video, image projected.

FIG. 25E is an illustration representative showing the scan field created in free space by the plurality of infrared lasers as a background and the projected multiple color laser pixel points on the white background.

FIG. 25F is an illustration representative showing the Free Space 2D or 3D Video created from infrared lasers, and visible light lasers in dimensional space

FIG. 25G is an illustration representative showing the person viewing the free space projected content.

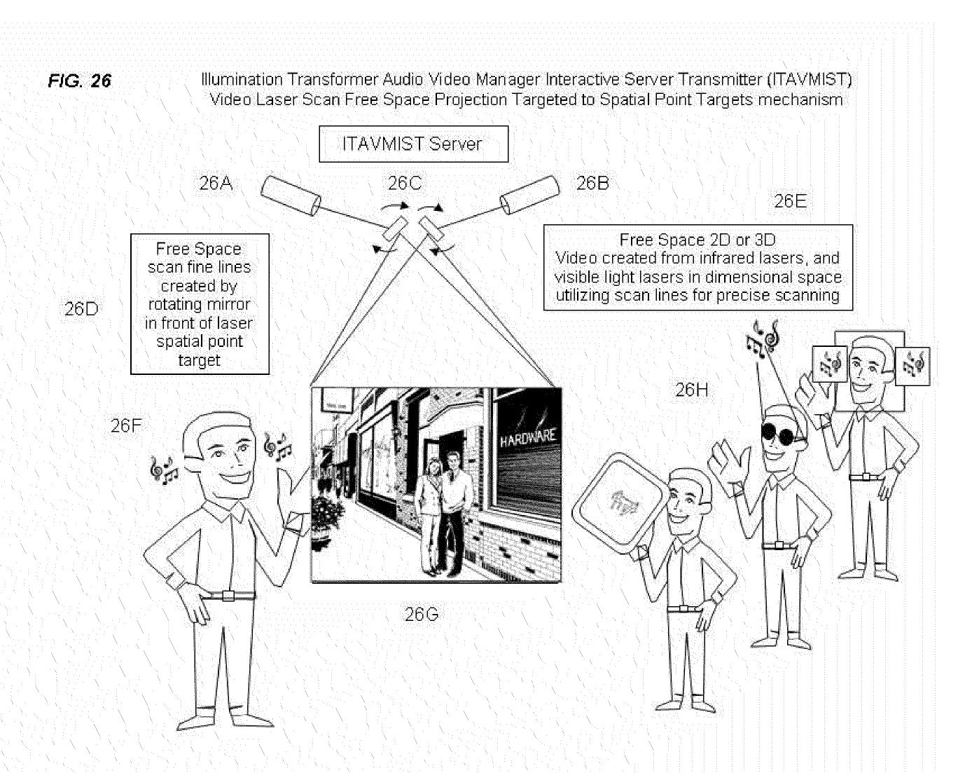

FIG. 26 is an illustration representative showing the Illumination Transformer Audio Video Manager Interactive Server Transmitter (ITAVMIST) Video Laser Scan Free Space Projection Targeted to Spatial Point Targets mechanism and further comprising a method and mechanism for new granular color spectrum of multiple colors for more vivid colors, in the recording of digital data for video and images, utilizing infrared laser with rotating mirror for creating a scan line in synchronization with another infrared laser to an intersecting point and scan lines created together to form a white background for free space projected pixels to create a video, image 3D, 2D at a specific spatial point target zone for viewing in ultra high definition or regular conventional definition.

FIG. 26A is an illustration representative showing the mechanism for new granular color spectrum of multiple colors for more vivid colors, in the recording of digital data for video and images, utilizing infrared laser

FIG. 26B is an illustration representative showing the mechanism for new granular color spectrum of multiple colors for more vivid colors, in the recording of digital data for video and images, utilizing infrared laser

FIG. 26C is an illustration representative showing the rotating mirror for creating a scan line in synchronization with another infrared laser to an intersecting point and scan lines created together to form a white background

FIG. 26D is an illustration representative showing the Free Space scan fine lines created by rotating mirror in front of laser spatial point target.

FIG. 26E is an illustration representative showing the Free Space 2D or 3D Video created from infrared lasers, and visible light lasers in dimensional space utilizing scan lines for precise scanning.

FIG. 26F is an illustration representative showing the user viewing content in free space.

FIG. 26G is an illustration representative showing the free space projected content.

FIG. 26H is an illustration representative showing the other variations of viewing with devices, wearable devices and free space viewing.

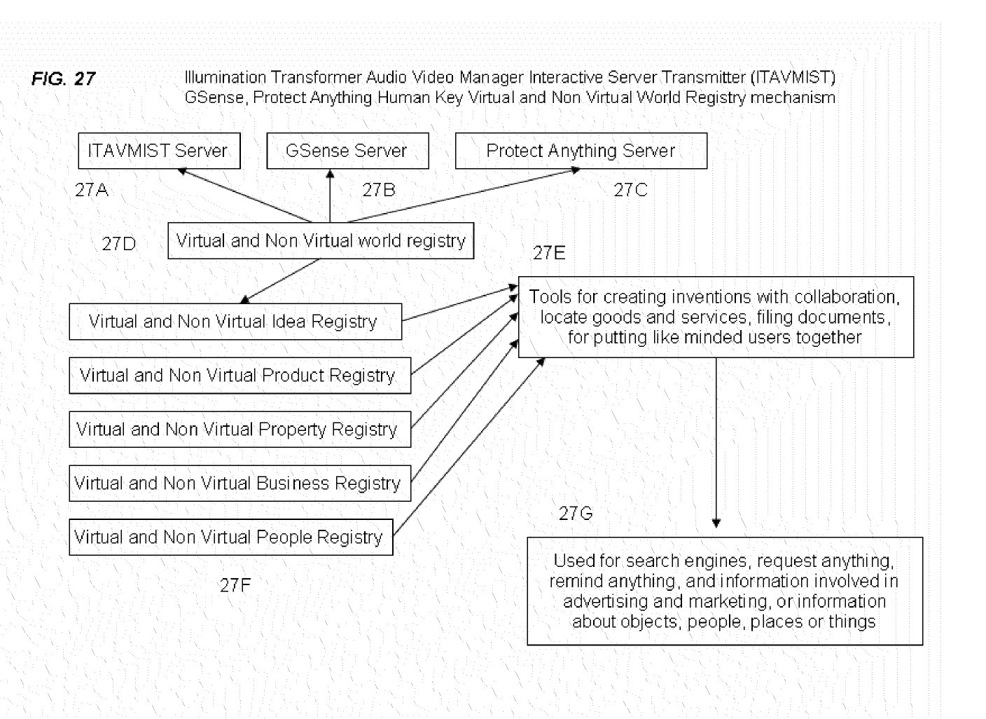

FIG. 27 is an illustration representative showing the Illumination Transformer Audio Video Manager Interactive Server Transmitter (ITAVMIST) GSense, Protect Anything Human Key Virtual and Non Virtual World Registry mechanism.

FIG. 27A is an illustration representative showing the ITAVMIST server.

FIG. 27B is an illustration representative showing the GSense server.

FIG. 27C is an illustration representative showing the Protect Anything server.

FIG. 27D is an illustration representative showing the Virtual World and Non Virtual World Registry.

FIG. 27E is an illustration representative showing the Virtual and Non Virtual Idea, product, property, business, people Registry.

FIG. 27F is an illustration representative showing the Tools for creating inventions with collaboration, locate goods and services, filing documents, for putting like minded users together.

FIG. 27G is an illustration representative showing the Used for search engines, request anything, remind anything, and information involved in advertising and marketing, or information about objects, people, places or things.

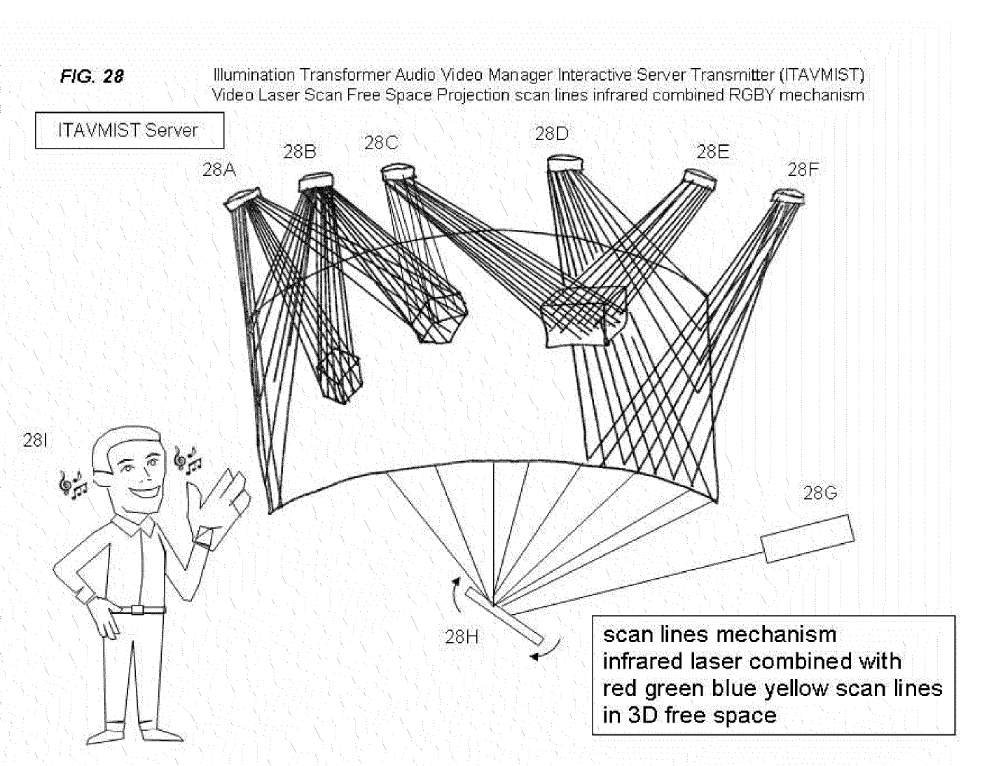

FIG. 28 is an illustration representative showing the Illumination Transformer Audio Video Manager Interactive Server Transmitter (ITAVMIST) Video Laser Scan Free Space Projection scan lines infrared combined RGBY mechanism.

FIG. 28A is an illustration representative showing the ITAVMIST server infrared laser background generator.

FIG. 28B is an illustration representative showing the ITAVMIST server laser color pixel generator.

FIG. 28C is an illustration representative showing the ITAVMIST server infrared laser background generator.

FIG. 28D is an illustration representative showing the ITAVMIST server server infrared laser background generator.

FIG. 28E is an illustration representative showing the ITAVMIST server laser color pixel generator.

FIG. 28F is an illustration representative showing the ITAVMIST server server infrared laser background generator.

FIG. 28G is an illustration representative showing the ITAVMIST server laser color pixel and infrared generator targeted to rotating mirror for scan lines.

FIG. 28H is an illustration representative showing the ITAVMIST rotating mirror for laser distribution of colors and background.

FIG. 28I is an illustration representative showing the user viewing and listening to content.

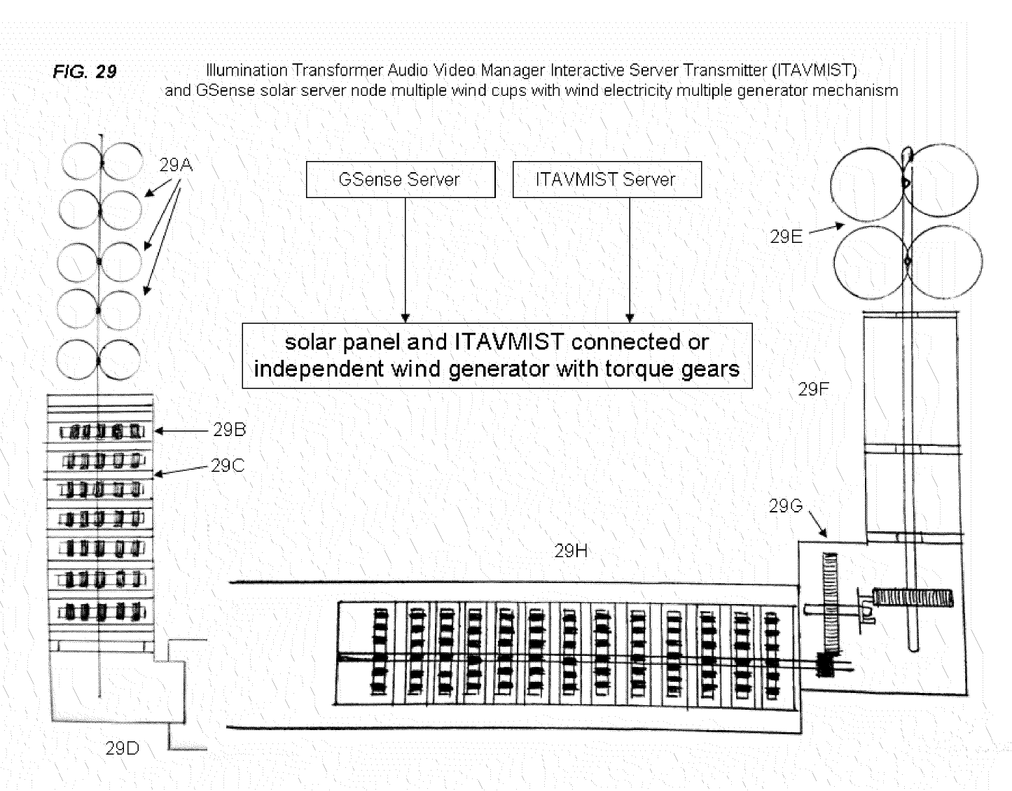

FIG. 29 is an illustration representative showing the Illumination Transformer Audio Video Manager Interactive Server Transmitter (ITAVMIST) and GSense solar server node multiple wind cups with wind electricity multiple generator mechanism.

FIG. 29A is an illustration representative showing the multiple wind cups for additional torque in generation.

FIG. 29B is an illustration representative showing the multiple magnet rotators.

FIG. 29C is an illustration representative showing the multiple stator coils.

FIG. 29D is an illustration representative showing the connection to the GSense and/or ITAVMIST main server node.

FIG. 29E is an illustration representative showing the multiple wind cups for extra torque.

FIG. 29F is an illustration representative showing the special light weight shaft design for having wind turbine generators inside the server mechanism.

FIG. 29G is an illustration representative showing the transmission gears for maximum torque.

FIG. 29H is an illustration representative showing the generators inside the server enclosure powered by the external wind turbine cups shaft assembly.

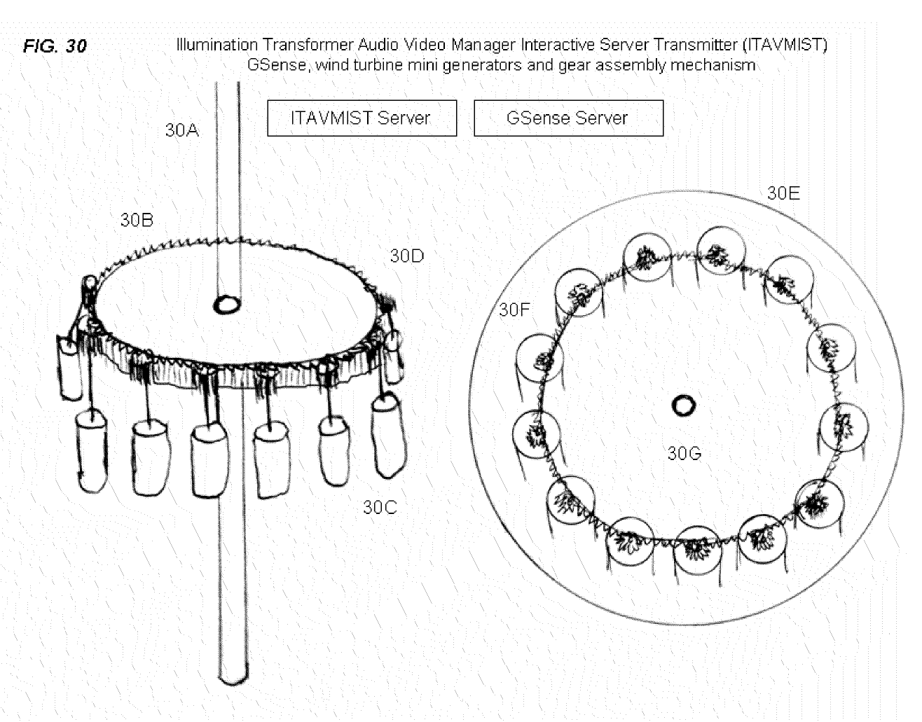

FIG. 30 is an illustration representative showing the Illumination Transformer Audio Video Manager Interactive Server Transmitter (ITAVMIST) GSense, wind turbine mini generators and gear assembly mechanism.

FIG. 30A is an illustration representative showing the wind turbine shaft.

FIG. 30B is an illustration representative showing the large torque gear.

FIG. 30C is an illustration representative showing the multiple wind generators.

FIG. 30D is an illustration representative showing the small gears attached to the multiple wind generators for maximum revolutions per minute.

FIG. 30E is an illustration representative showing the supporting mini generator mounting disk.

FIG. 30F is an illustration representative showing the placement of mini generators with small gears for high torque.

FIG. 30G is an illustration representative showing the center wind turbine shaft hole and large gear for maximum torque.

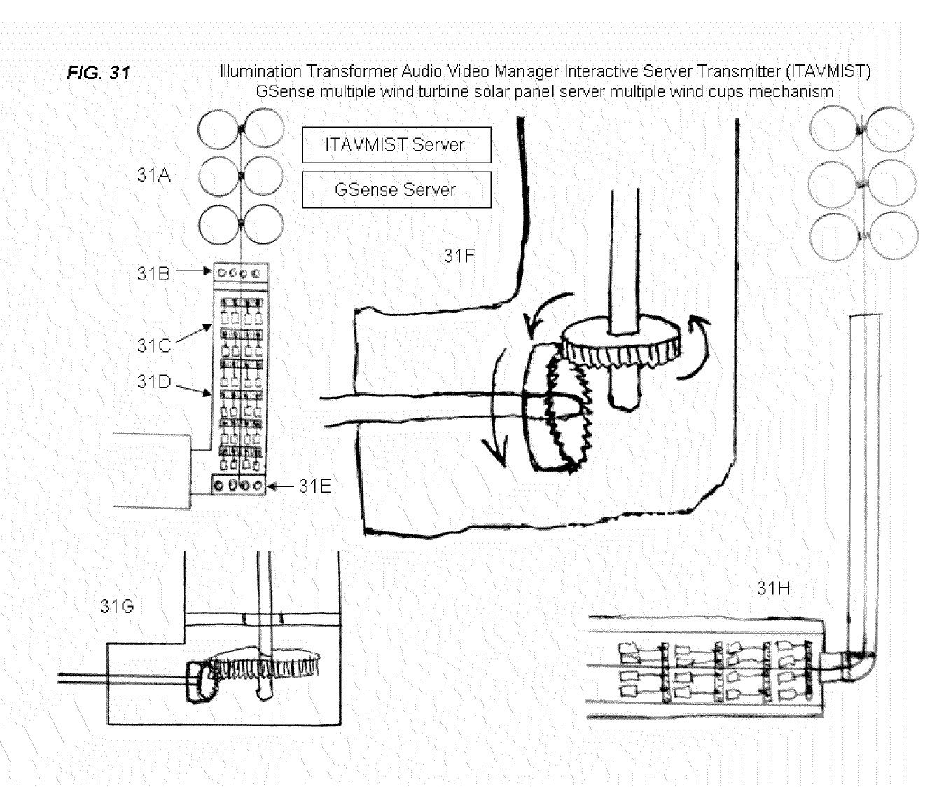

FIG. 31 is an illustration representative showing the Illumination Transformer Audio Video Manager Interactive Server Transmitter (ITAVMIST) GSense multiple wind turbine solar panel server multiple wind cups mechanism.

FIG. 31A is an illustration representative showing the multiple cups for the higher torque.

FIG. 31B is an illustration representative showing the magnetic motor for additional torque.

FIG. 31C is an illustration representative showing the multiple mini generators with small gears for maximum torque.

FIG. 31D is an illustration representative showing the large gear for creating maximum RPM's at the mini wind generators.

FIG. 31E is an illustration representative showing the second magnetic motor for additional torque during start up of turbine.

FIG. 31F is an illustration representative showing the close up of the gear mechanism.

FIG. 31G is an illustration representative showing the connector point to the server unit.

FIG. 31H is an illustration representative showing the turbines built into the GSense or ITAVMIST server node unit.

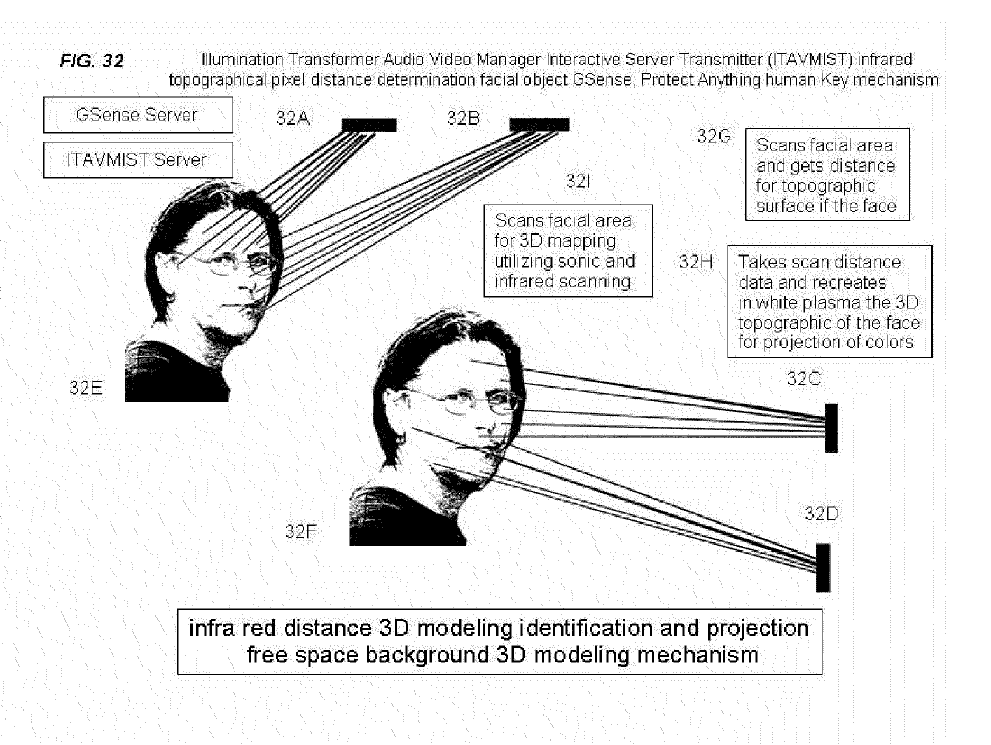

FIG. 32 is an illustration representative showing the Illumination Transformer Audio Video Manager Interactive Server Transmitter (ITAVMIST) infrared topographical pixel distance determination facial object GSense, Protect Anything human Key mechanism.

FIG. 32A is an illustration representative showing the infrared pixel distance detector of the facial area from the ITAVMIST server node.

FIG. 32B is an illustration representative showing the second infrared pixel distance detector of the facial area from the ITAVMIST server node.

FIG. 32C is an illustration representative showing the infrared pixel distance detector of the facial front projection area for human key distance aggregation.

FIG. 32D is an illustration representative showing the second infrared pixel distance detector of the facial front projection area for human key distance aggregation.

FIG. 32E is an illustration representative showing the subjects face being identified in a space.

FIG. 32F is an illustration representative showing the subjects face being enrolled, registered and identified in a space.

FIG. 32G is an illustration representative showing where the mechanism scans facial area and gets distance for topographic surface of the face.

FIG. 32H is an illustration representative showing where the mechanism takes scan distance data and recreates in white plasma the 3D topographic of the face for projection of colors.

FIG. 32I is an illustration representative showing where the mechanism scans facial area for 3D mapping utilizing sonic and infrared scanning.

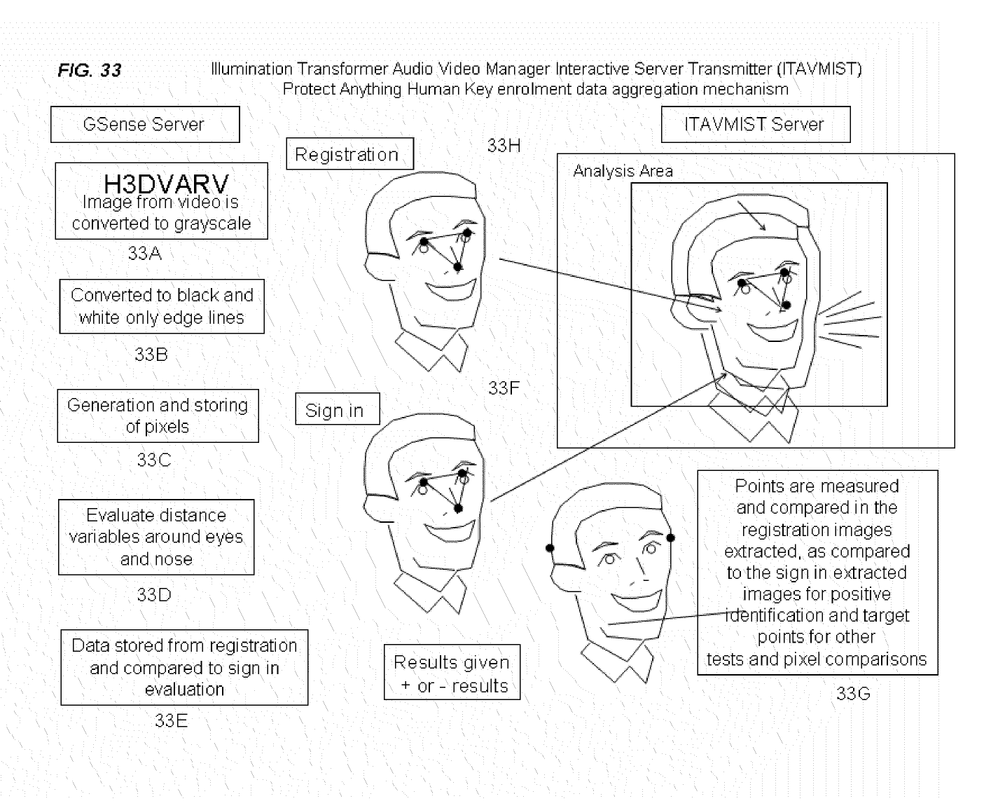

FIG. 33 is an illustration representative showing the Illumination Transformer Audio Video Manager Interactive Server Transmitter (ITAVMIST) Protect Anything Human Key enrollment data aggregation mechanism.

FIG. 33A is an illustration representative showing H3DVARV the Image from video is converted to grayscale.

FIG. 33B is an illustration representative showing the Converted to black and white only edge lines.

FIG. 33C is an illustration representative showing the Generation and storing of pixels.

FIG. 33D is an illustration representative showing the Evaluate distance variables around eyes and nose.

FIG. 33E is an illustration representative showing the Data stored from registration and compared to sign in evaluation.

FIG. 33F is an illustration representative showing the sign in triangulation mechanism.

FIG. 33G is an illustration representative showing the Points are measured and compared in the registration images extracted, as compared to the sign in extracted images for positive identification and target points for other tests and pixel comparisons.

FIG. 33H is an illustration representative showing the registration analysis area.

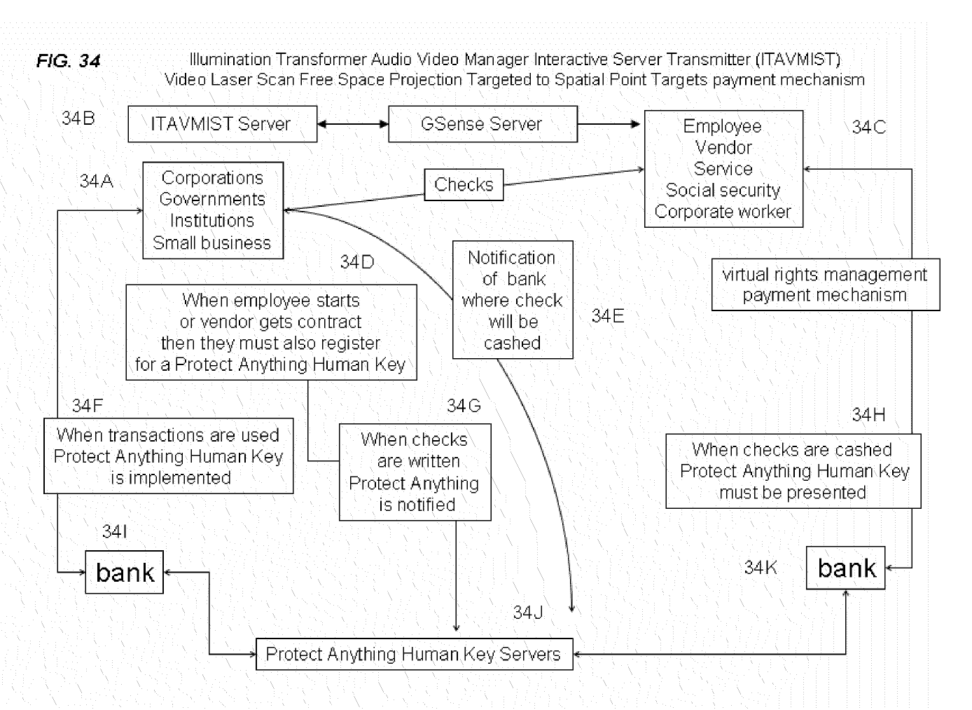

FIG. 34 is an illustration representative showing the Illumination Transformer Audio Video Manager Interactive Server Transmitter (ITAVMIST) Video Laser Scan Free Space Projection Targeted to Spatial Point Targets payment mechanism.

FIG. 34A is an illustration representative showing the corporations, governments, institutions, small business, and users in the mechanism.

FIG. 34B is an illustration representative showing the ITAVMIST server sending data to the GSense server for processing payments.

FIG. 34C is an illustration representative showing the Employee Vendor Service Social security Corporate worker abilities for payments and cashing checks system.

FIG. 34D is an illustration representative showing the When employee starts or vendor gets contract then they must also register for a Protect Anything Human Key.

FIG. 34E is an illustration representative showing the Notification of bank where check will be cashed part of the mechanism.

FIG. 34F is an illustration representative showing where when transactions are used Protect Anything Human Key is implemented.

FIG. 34G is an illustration representative showing where when checks are written Protect Anything is notified.

FIG. 34H is an illustration representative showing where when checks are cashed Protect Anything Human Key must be presented.

FIG. 34I is an illustration representative showing the bank.

FIG. 34J is an illustration representative showing the Protect Anything Human Key.

FIG. 34K is an illustration representative showing the bank.

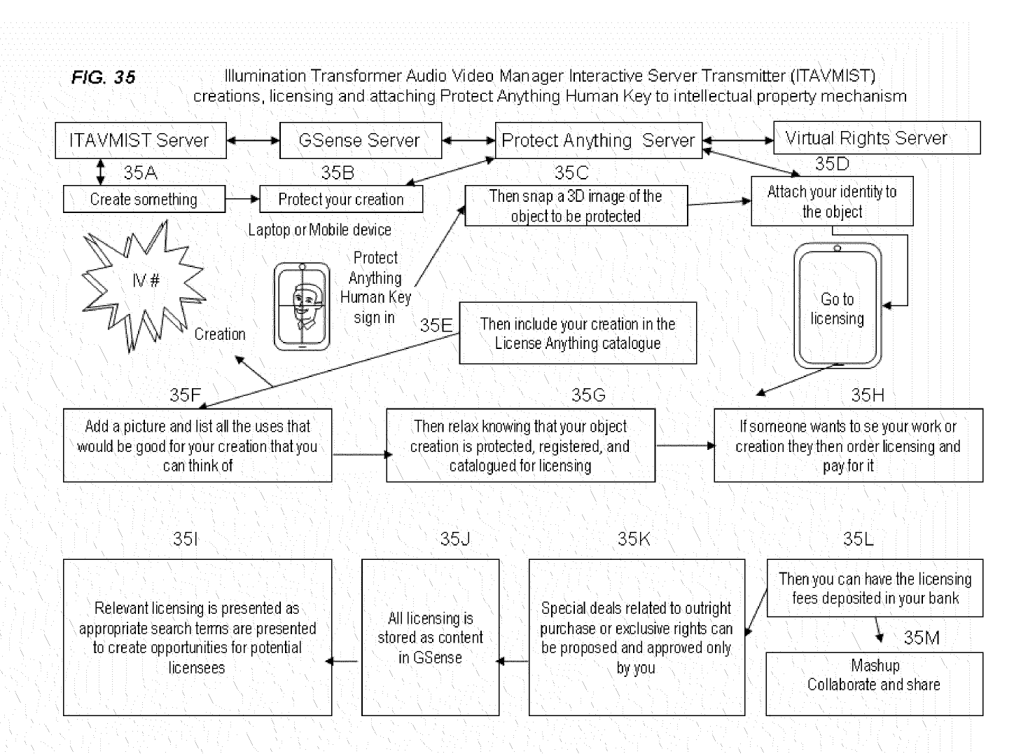

FIG. 35 is an illustration representative showing the Illumination Transformer Audio Video Manager Interactive Server Transmitter (ITAVMIST) creations, licensing and attaching Protect Anything Human Key to intellectual property mechanism.

FIG. 35A is an illustration representative showing the create something aspect.

FIG. 35B is an illustration representative showing protect your creation aspect.

FIG. 35C is an illustration representative showing where a user then snaps a 3D image of the object to be protected.

FIG. 35D is an illustration representative showing where user can attach identity to the object.

FIG. 35E is an illustration representative showing the system include your creation in the License Anything catalogue.

FIG. 35F is an illustration representative showing Add a picture and list all the uses that would be good for your creation that you can think of.

FIG. 35G is an illustration representative showing then relax knowing that your object creation is protected, registered, and catalogued for licensing.

FIG. 35H is an illustration representative showing If someone wants to se your work or creation they then order licensing and pay for it.

FIG. 35I is an illustration representative showing Relevant licensing is presented as appropriate search terms are presented to create opportunities for potential licensees.

FIG. 35J is an illustration representative showing all licensing is stored as content in GSense.

FIG. 35K is an illustration representative showing special deals related to outright purchase or exclusive rights can be proposed and approved only by you.

FIG. 35L is an illustration representative showing then you can have the licensing fees deposited in your bank.

FIG. 35M is an illustration representative showing the mashup and collaboration mechanism.

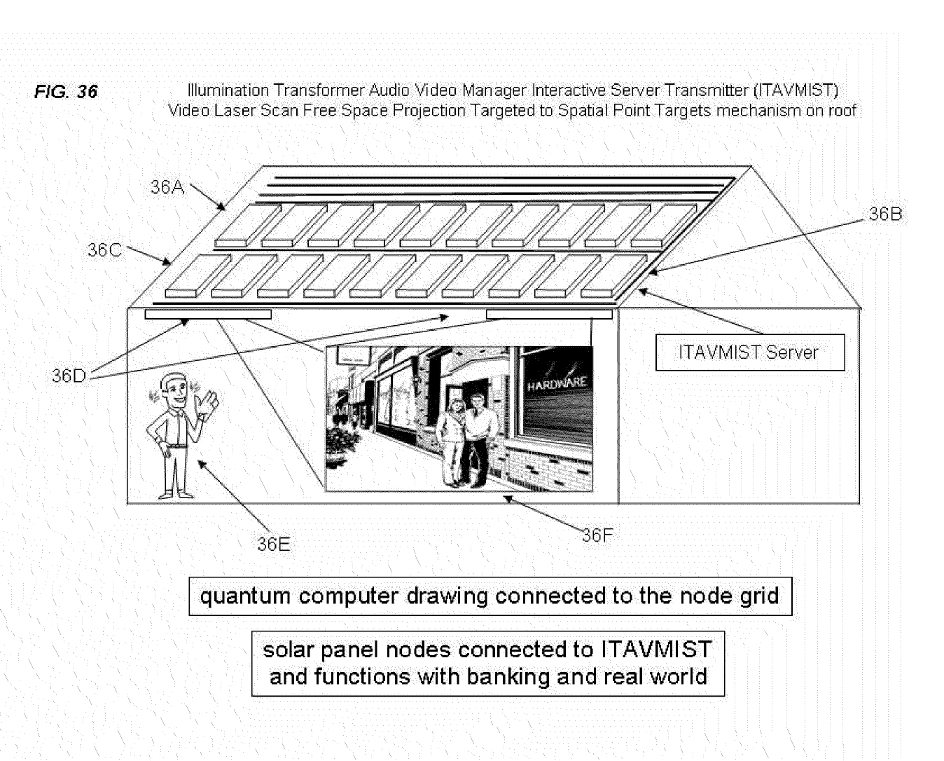

FIG. 36 is an illustration representative showing the Illumination Transformer Audio Video Manager Interactive Server Transmitter (ITAVMIST) Video Laser Scan Free Space Projection Targeted to Spatial Point Targets mechanism on roof and solar panel nodes connected to ITAVMIST and functions with banking and real world.

FIG. 36A is an illustration representative showing the GSense solar server nodes.

FIG. 36B is an illustration representative showing the iTAVMIST server.

FIG. 36C is an illustration representative showing the GSense VOIP server.

FIG. 36D is an illustration representative showing the ITAVMIST laser projection units.

FIG. 36E is an illustration representative showing a user viewing projection and sound.

FIG. 36F is an illustration representative showing a projection of a movie.

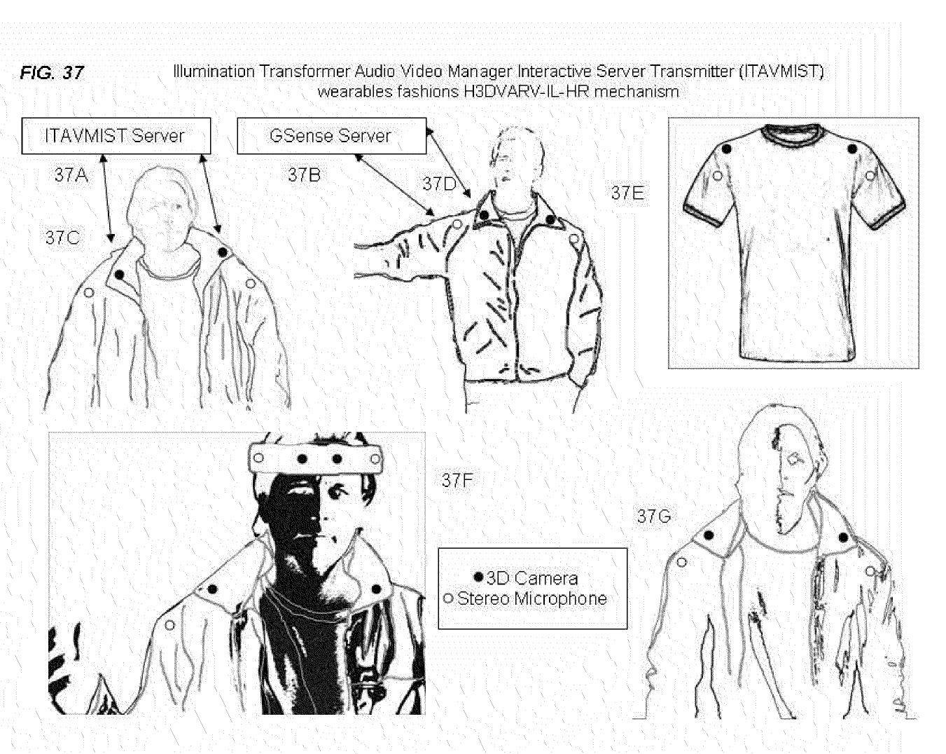

FIG. 37 is an illustration representative showing the Illumination Transformer Audio Video Manager Interactive Server Transmitter (ITAVMIST) wearables fashions H3DVARV-IL-HR mechanism.

FIG. 37A is an illustration representative showing the ITAVMIST server.

FIG. 37B is an illustration representative showing the GSense server.

FIG. 37C is an illustration representative showing the wearables fashion mechanism with 3D cams, and stereo microphones.

FIG. 37D is an illustration representative showing the wearables fashion mechanism with 3D cams, and stereo microphones.

FIG. 37E is an illustration representative showing the wearables fashion mechanism with 3D cams, and stereo microphones.

FIG. 37F is an illustration representative showing the wearables fashion mechanism with 3D cams, and stereo microphones in headband, and jacket.

FIG. 37G is an illustration representative showing the wearables fashion mechanism with 3D cams, and stereo microphones.

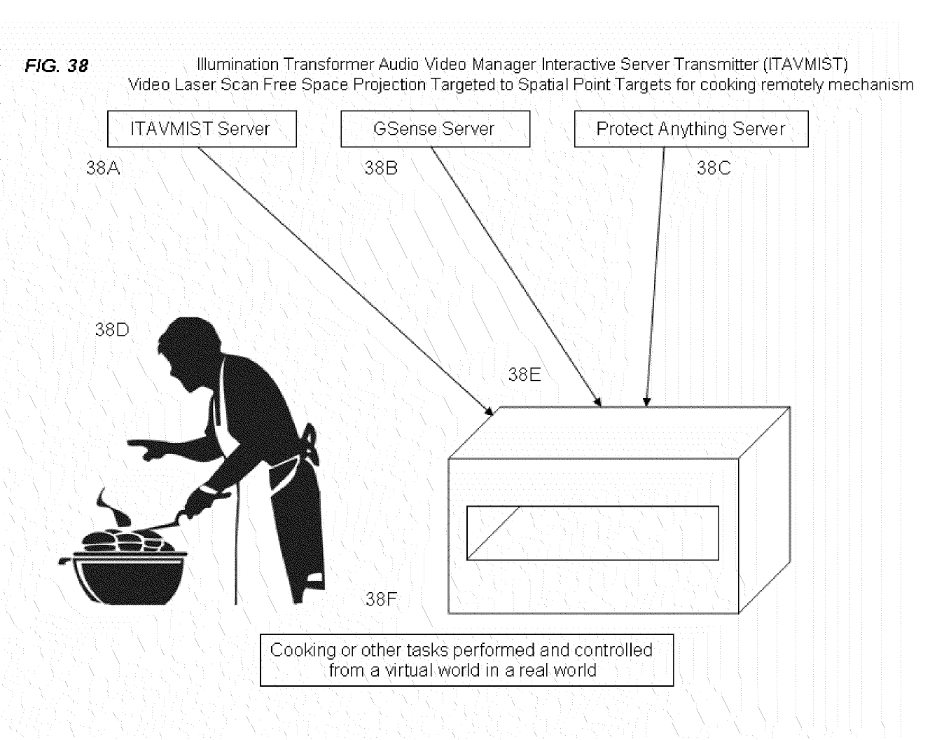

FIG. 38 is an illustration representative showing the Illumination Transformer Audio Video Manager Interactive Server Transmitter (ITAVMIST) Video Laser Scan Free Space Projection Targeted to Spatial Point Targets for cooking remotely mechanism.

FIG. 38A is an illustration representative showing the ITAVMIST server.

FIG. 38B is an illustration representative showing the GSense server.

FIG. 38C is an illustration representative showing the Protect Anything Human Key server.

FIG. 38D is an illustration representative showing the regular way of cooking.

FIG. 38E is an illustration representative showing the remote device for cooking controlled from a virtual world.

FIG. 38F is an illustration representative showing the cooking or other tasks performed and controlled from a virtual world in a real world.

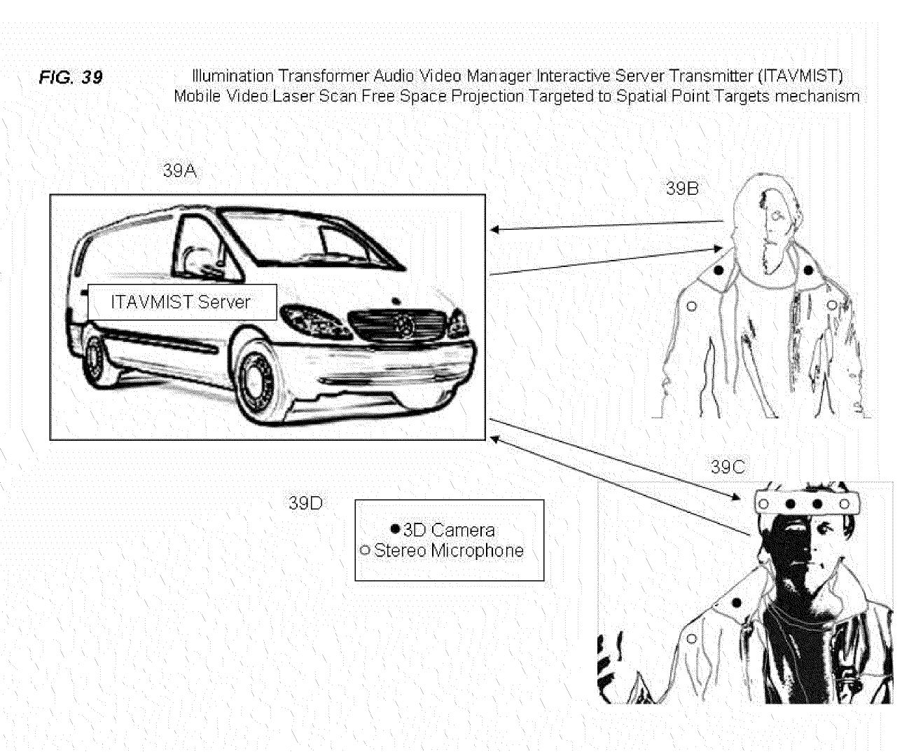

FIG. 39 is an illustration representative showing the Illumination Transformer Audio Video Manager Interactive Server Transmitter (ITAVMIST) Mobile Video Laser Scan Free Space Projection Targeted to Spatial Point Targets mechanism.

FIG. 39A is an illustration representative showing the ITAVMIST server unit in mobile van.

FIG. 39B is an illustration representative showing the wearables cameras and microphones, transmitting to the mobile ITAVMIST server.

FIG. 39C is an illustration representative showing the wearables headband and jacket cameras and microphones, transmitting to and getting transmissions from the mobile ITAVMIST server.

FIG. 39D is an illustration representative showing the 3D cameras and stereo microphones.

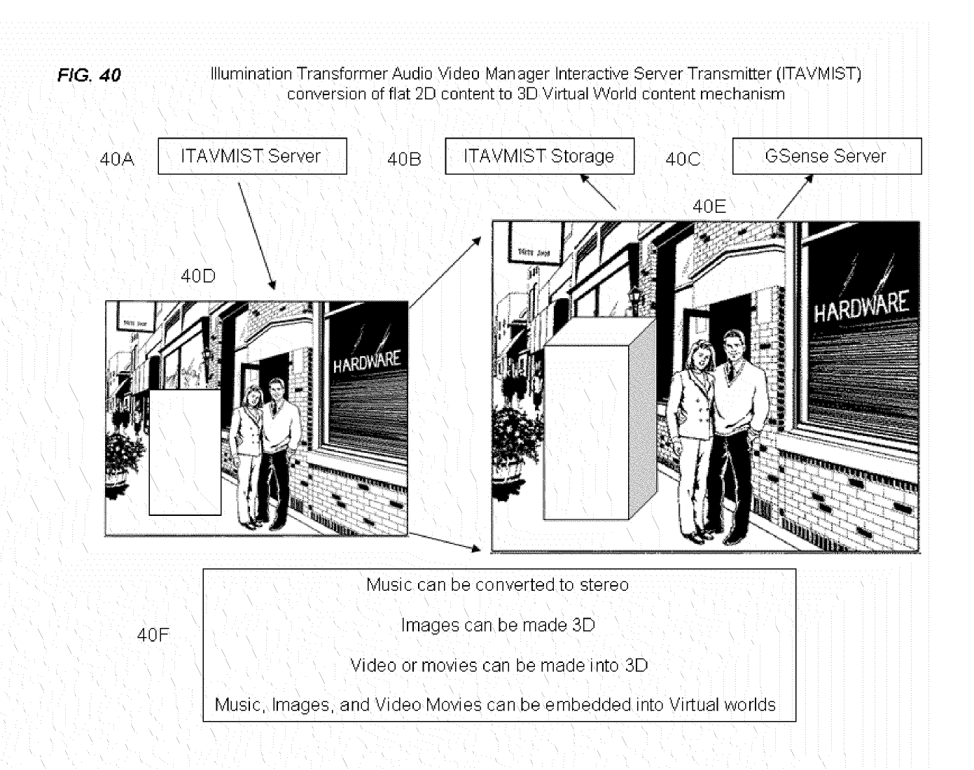

FIG. 40 is an illustration representative showing the Illumination Transformer Audio Video Manager Interactive Server Transmitter (ITAVMIST) conversion of flat 2D content to 3D Virtual World content mechanism.

FIG. 40A is an illustration representative showing the ITAVMIST server.

FIG. 40B is an illustration representative showing the ITAVMIST storage.

FIG. 40C is an illustration representative showing the GSense server.

FIG. 40D is an illustration representative showing the 2D content.

FIG. 40E is an illustration representative showing the 3D content.

FIG. 40F is an illustration representative showing the Music can be converted to stereo Images can be made 3D Video or movies can be made into 3D Music, Images, and Video Movies can be embedded into Virtual worlds.

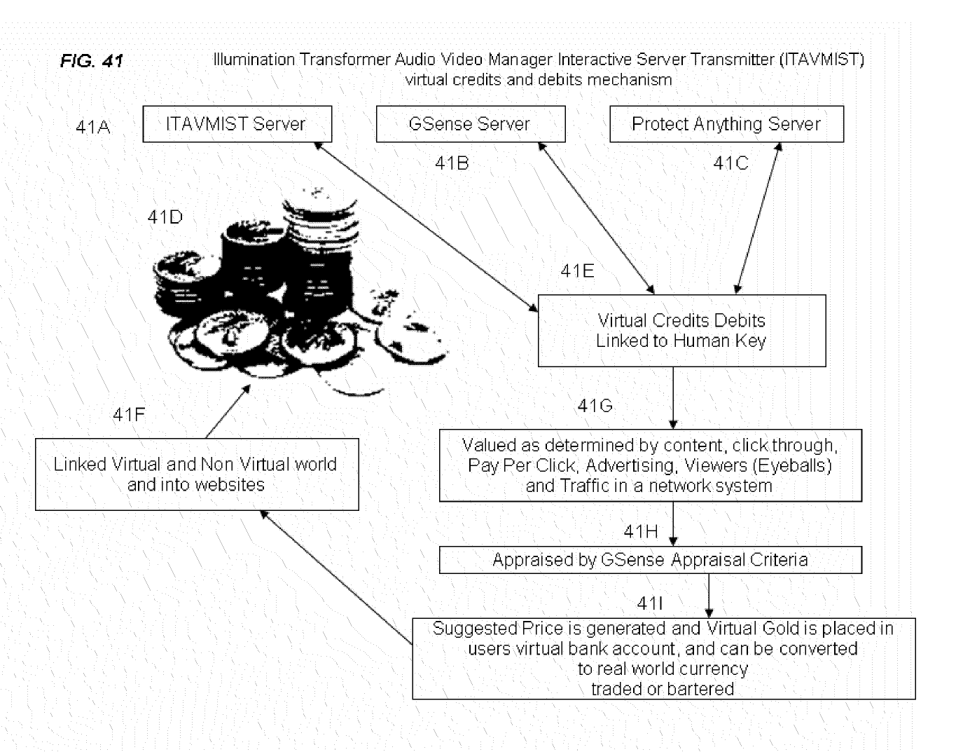

FIG. 41 is an illustration representative showing the Illumination Transformer Audio Video Manager Interactive Server Transmitter (ITAVMIST) virtual credits and debits mechanism.

FIG. 41A is an illustration representative showing the ITAVMIST server.

FIG. 41B is an illustration representative showing the GSense server.

FIG. 41C is an illustration representative showing the Protect Anything Human Key server.

FIG. 41D is an illustration representative showing the virtual coins for use in virtual world.

FIG. 41E is an illustration representative showing the Virtual Credits Debits Linked to Human Key.

FIG. 41F is an illustration representative showing the Linked Virtual and Non Virtual world and into websites.

FIG. 41G is an illustration representative showing the Valued as determined by content, click through, Pay Per Click, Advertising, Viewers (Eyeballs) and Traffic in a network system.

FIG. 41H is an illustration representative showing the appraised by GSense Appraisal Criteria.

FIG. 41I is an illustration representative showing the Suggested Price is generated and Virtual Gold is placed in users virtual bank account, and can be converted to real world currency traded or bartered.

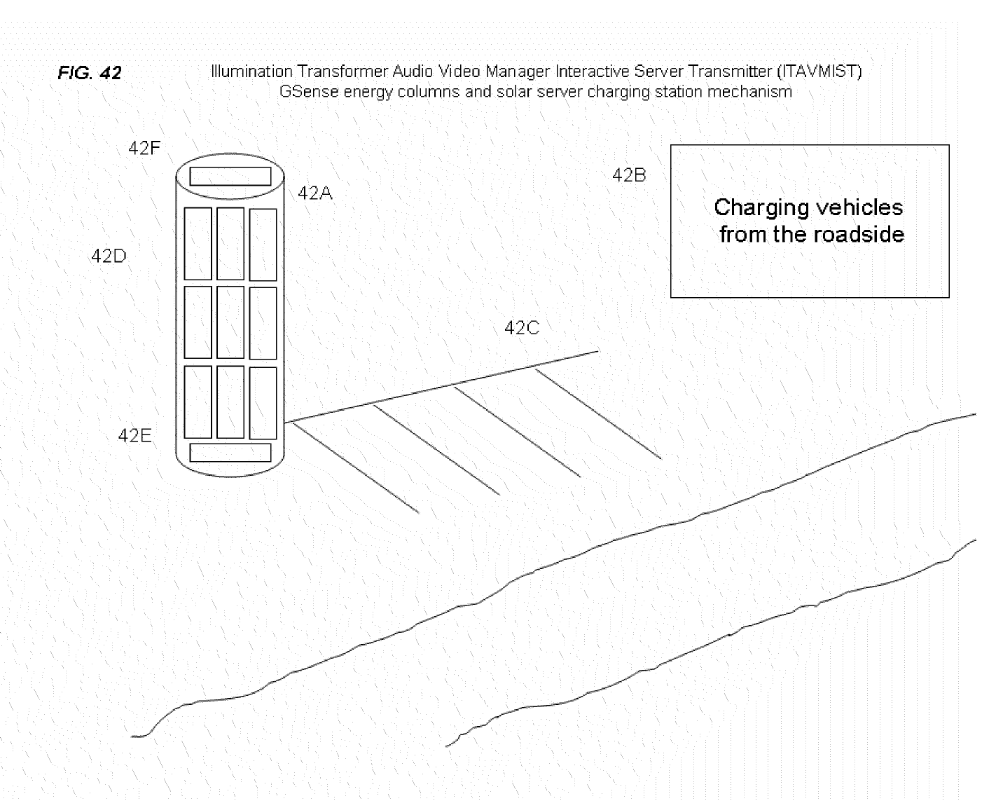

FIG. 42 is an illustration representative showing the Illumination Transformer Audio Video Manager Interactive Server Transmitter (ITAVMIST) GSense energy columns and solar server charging station mechanism.

FIG. 42A is an illustration representative showing the charging station column.

FIG. 42B is an illustration representative showing the charging vehicles from the roadside when electric cars need charging.

FIG. 42C is an illustration representative showing the parking spots for charging.

FIG. 42D is an illustration representative showing the GSense curved solar server nodes.

FIG. 42E is an illustration representative showing the battery storage area.

FIG. 42F is an illustration representative showing the ITAVMIST server node.

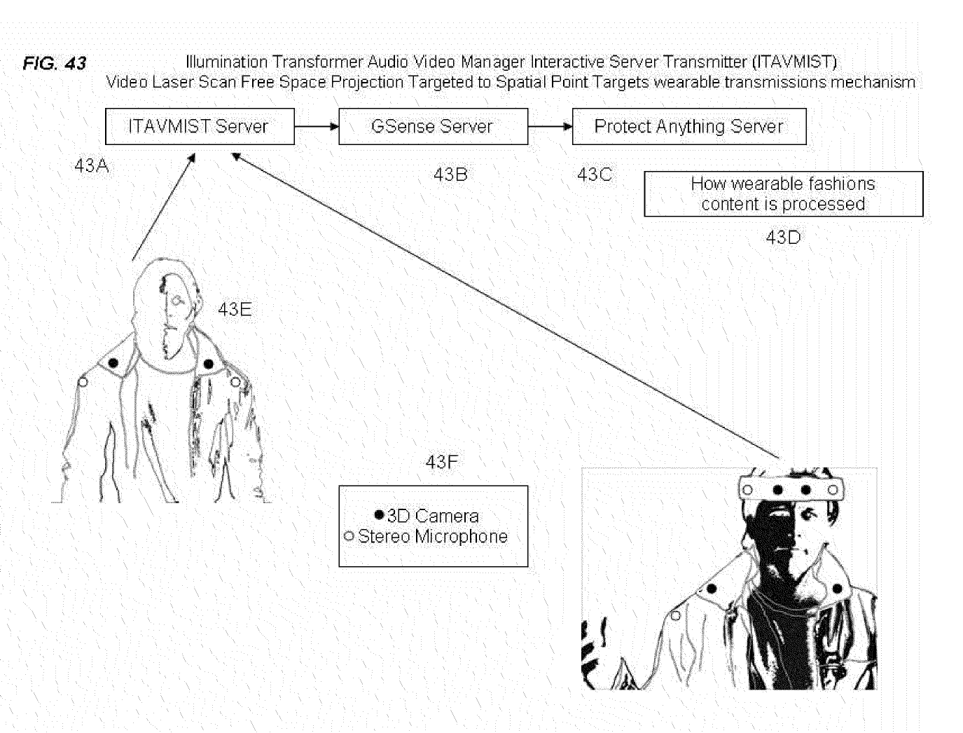

FIG. 43 is an illustration representative showing the Illumination Transformer Audio Video Manager Interactive Server Transmitter (ITAVMIST) Video Laser Scan Free Space Projection Targeted to Spatial Point Targets wearable transmissions mechanism.

FIG. 43A is an illustration representative showing the ITAVMIST server.

FIG. 43B is an illustration representative showing the GSense server.

FIG. 43C is an illustration representative showing the Protect Anything Human Key server.

FIG. 43D is an illustration representative showing how wearable fashions content are processed.

FIG. 43E is an illustration representative showing the wearables with multiple cameras and microphones transmitting to the ITAVMIST server.

FIG. 43F is an illustration representative showing the 3D cameras and stereo microphones are located.

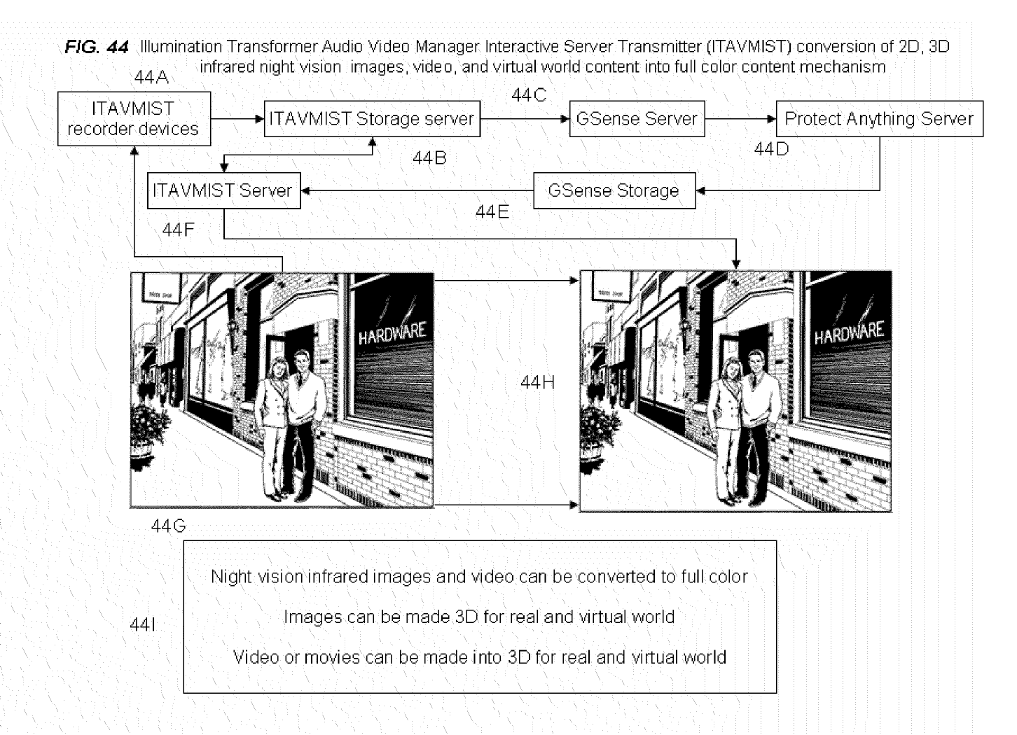

FIG. 44 is an illustration representative showing Illumination Transformer Audio Video Manager Interactive Server Transmitter (ITAVMIST) conversion of 2D, 3D infrared night vision images, video, and virtual world content into full color content mechanism.

FIG. 44A is an illustration representative showing the ITAVMIST recorder devices.

FIG. 44B is an illustration representative showing the ITAVMIST Storage server.

FIG. 44C is an illustration representative showing the GSense Server.

FIG. 44D is an illustration representative showing the Protect Anything Server.

FIG. 44E is an illustration representative showing the GSense Storage.

FIG. 44F is an illustration representative showing the ITAVMIST Server.

FIG. 44G is an illustration representative showing the infrared night vision monotone image.

FIG. 44H is an illustration representative showing the full color image.

FIG. 44I is an illustration representative showing the Night vision infrared images and video can be converted to full color Images can be made 3D for real and virtual world Video or movies can be made into 3D for real and virtual world.

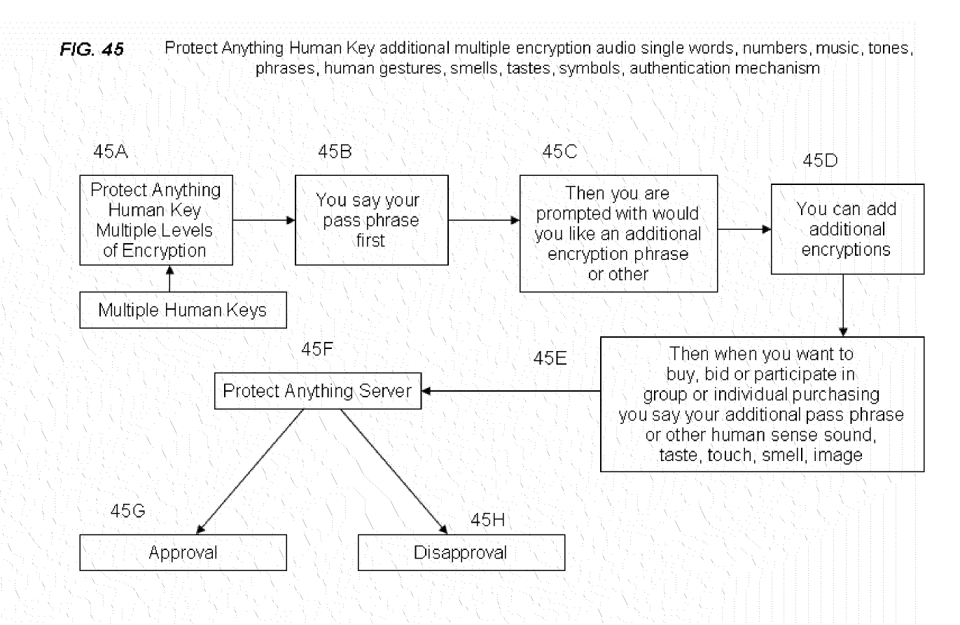

FIG. 45 is an illustration representative showing the Protect Anything Human Key additional multiple encryption audio single words, numbers, music, tones, phrases, human gestures, smells, tastes, symbols, authentication mechanism.

FIG. 45A is an illustration representative showing the Protect Anything Human Key Multiple Levels of Encryption.

FIG. 45B is an illustration representative showing you say your pass phrase first.

FIG. 45C is an illustration representative showing then you are prompted with would you like an additional encryption phrase or other.

FIG. 45D is an illustration representative showing you can add additional encryptions.

FIG. 45E is an illustration representative showing Then when you want to buy, bid or participate in group or individual purchasing you say your additional pass phrase or other human sense sound, taste, touch, smell, image.

FIG. 45F is an illustration representative showing the protect Anything Human Key server.

FIG. 45G is an illustration representative showing the Approval.

FIG. 45H is an illustration representative showing the disapproval.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. An apparatus for secure recording and transformation of images to light for identification, and audio visual projection to spatial point targeted area comprising:
a device that takes one laser beam and multiplies the beam to project a plurality of low level laser beams at specific spatial point targets as targeted by one or more illumination transformer audio video manager interactive server transmitter server node(s) installed at a specific spatial point target, which is used as a reference point for all spatial points in the space;
a first mechanism that utilizes multiple illumination transformer audio video manager interactive server transmitter server node(s) infrared lasers or visible light amplification laser module units in a space to precisely target and places a laser columnar of light at any point in a three Dimensional space;
a second mechanism that creates consistent variable temperatures, utilizing a plurality of laser beams that are shaped and focused to a smaller variable size and targeted to a single specific spatial point, whereby multiple lasers create a desired temperature at the target point, and targeting and intensity of the laser;
a third mechanism where a plurality of laser beams intersect at a single point and create a certain infrared generated temperature, and any additional plurality of laser beams at the intersect point creates a higher temperature;
the illumination transformer audio video manager interactive server transmitter server node(s) can convert and transform uploaded recorded video and media into a spatial point targeted infrared screen array projection for viewing at any spatial point targeted zone managed by illumination transformer audio video manager interactive server transmitter server node(s),
a rotating micro mirrors for each pixel to cut on or off laser transmissions, utilizing an array of multiple pixel transmitters, in a plurality of on/off mirror servos;
a fourth mechanism that transforms pixel colors assigned to different temperatures within a plurality of base ambient temperatures for automatic compensation of the surrounding temperatures so that the base ambient temperature is consistently the color black of the spectrum and the other colors blue, green, red, and yellow are represented from the base as the temperature increases until a temperature equals the color white;
the illumination transformer audio video manager interactive server transmitter server node(s) unit evaluates the temperature to color matrix then reevaluates at various time frames for quality adjustment of transmissions;
the illumination transformer audio video manager interactive server transmitter server node(s) delivers pin point accuracy in delivering selective infrared and visible light emitted to fine points for temperature creation at those targeted points, plus interpolated thermal heat pixel, focused and shaped automatically into pixel points instantaneously created to size of requested video display screen size; and
a fifth mechanism for intersecting infrared laser beams to create spatial targeted pixel points of white plasma background, that has visible light utilizing red, green, blue, yellow lasers intersected on the white plasma to change the color of the pixel instantly for creating free spatial point targeted arrays for projection of video, text, data, and images.

22. The apparatus of claim 1, wherein the illumination transformer audio video manager interactive server transmitter server node(s) additionally comprises a laser device to transmit audio, images, text and video utilizing light transmission infrared or visible light amplification lasers to a spatial point target device for vision, hearing, smell, taste, and touch identification and sensing to and from the illumination transformer audio video manager interactive server transmitter server node(s) for advertising and marketing point of purchase, point of sale, point of use, point of incentive, point of demonstration, and point of variable incentive.

23. The apparatus of claim 1, wherein the illumination transformer audio video manager interactive server transmitter server node(s) further comprises;
a plurality of devices with sensors for the five human senses of hearing, smell, taste, touch, and vision for sensing and storage of generated sounds, vision, smells, touch, and taste; and
an illumination transformer audio video manager Interactive server Transmitter server node(s) system mechanism for sending and receiving senses data.

24. The apparatus of claim 1, wherein the illumination transformer audio video manager interactive server transmitter server node(s) additionally comprises a spatial point audio video transmitter and receiver device that identifies humans and shuts off or turns on devices inside the main server components, and which is a switching mechanism that can automatically turn itself off or on when an object moves within the path of spatial points within an area of a space that the mechanism is managing.

25. The apparatus of claim 1, wherein the illumination transformer audio video manager interactive server transmitter server node(s) further comprises;
a sixth mechanism that shows variable spectrum colors that change accordingly to temperatures generated at spatial point laser intercept targets, and the result that is produced when viewed with the illumination transformer audio video manager interactive server transmitter server node(s) special devices such as embedded goggles, eyewear, or an eye glass clip-on device where the temperature points are transformed into colors and patterns that the human eye can view; and
the embedded goggles, eyewear, or eye glass clip-on device are equipped with the ability to record and transmit wirelessly to the illumination transformer audio video manager interactive server transmitter server node(s) unit.

26. The apparatus of claim 1, wherein the illumination transformer audio video manager interactive server transmitter server node(s) additionally comprises an infrared laser color band audio track mechanism for transforming infrared laser points merged into color array of video and images projected by illumination Transformer Audio Video Manager interactive server transmitter server node(s) system and transmitted to spatial point targeted zone, that can be read and processed and can be transformed into binaural stereo sound, and the color band audio track is transmitted by a server node to the edge of the spatial point virtual screen, or all four edges for multiple track audio listening.

27. The apparatus of claim 1, wherein the illumination transformer audio video manager interactive server transmitter server node(s) additionally comprises a mechanism that takes digital or quantum computer content and utilizing a laser beam which projects to a device that further projects video, text, data, audio at free spatial point target.

28. The apparatus of claim 1, wherein the illumination transformer audio video manager interactive server transmitter server node(s) additionally comprises a mechanism projecting virtual worlds, and real world events to a free spatial point targeted area.

29. The apparatus of claim 1, wherein the illumination transformer audio video manager interactive server transmitter server node(s) additionally comprises a mechanism that can process protected transactions with the protect anything human key for pay per view, pay per listen, ticketed events, or any transaction and additionally the authorized user(s) turn on or turn off individual or specific targeted content in local geographic areas, and allow users to collaborate with others securely using protect anything human key authorization, and still further the devices have a protect anything human key attached, so that other users can not use your device without your unique identity.

30. The apparatus of claim 1, wherein the illumination transformer audio video manager interactive server transmitter server node(s) additionally comprises a mechanism where messages including audio, video, text, and data can be presented in a free space, on a device, or attached to a product that a potential buyer, seller or user touches, reaches out for, or requests information about;
a handheld or portable device can learn information about a product, goods or service;
a server used for identifying products, goods and/or services; and
a seventh mechanism is used for ordering, buying and selling transactions, suggestions for advertising, demonstrations and tutorials at a point of purchase, display or sale, online and offline, and recommendations, reminders, and requests that are connected to smart machines and/or machines that use artificial intelligence.

31. The apparatus of claim 1, wherein the illumination transformer audio video manager interactive server transmitter server node(s) additionally comprises:
an eighth mechanism for a plurality of surface-emitting lasers, using lasers with fine columns of light a fraction of the size of a hair, and very small crystal lasers, for utilizing very small crystals that emit bright, fluorescent light in different hues, infrared laser, and lasers, utilizing crystals, beam splitters and lenses to reduce the wavelengths to emitting beams of red, green, blue, or yellow light, that is targeted to an array of multiple nano and/or very small scale mirrors, that singularly and multiplied together represents a single nano and/or very small scale laser pixel;
the mirrors are controlled by the main mechanism to spin, for scanned on and off positioning, with intensity controlling intersected beams in a plurality of adjustable variable sized spectral colors, combined into an ultra-high resolution laser display and bright color image and video viewing, reflected off surface of infrared intersecting laser pixel background that forms white plasma surface for projection, in 2D flat screen and 3D embossed free spatial point targeted pixel array background of white plasma, in any shape that is recorded by one or more free spatial point targeted pixel array cameras.

32. The apparatus of claim 1, wherein
the illumination transformer audio video manager interactive server transmitter server node(s) managed space transmissions can be projected and viewed through smoke, clouds, water vapor, dust, on surfaces, or non surfaces such as free space; and
the apparatus can form images, video, text, data and audio utilizing a plurality of combinations of lasers targeted to specific array of spatial point targets in free space.

33. The apparatus of claim 1, further comprising:
a ninth mechanism which utilizes a double thresh-hold and density slicing management apparatus built in that divides the range of brightness in a single band into intervals, and then assigns each interval to a specific color split into pixel area bands, and each pixel area band is represented by a color, with a base target temperature that represents the color black that is assigned to the current ambient temperature in the managed space by the illumination transformer audio video manager interactive server transmitter server node(s) management unit, for viewing thermal video or images displayed.

34. The apparatus of claim 1, further comprising:
a device wearable camera recorder, communicating with ITAVMIST server node(s);
device wearable camera recorder recording in darkness and light; and
the server node(s) transforming video and images into full color from low level lighting situations.

35. The apparatus of claim 1, further comprising:
multiple track audio can be transmitted in a curve with the virtual world curved viewer screen, and then sound is integrated into spatial point targets in video for more realistic sound effects,
special targeted sound and video cubes or zones for transmission viewing and listening; and
where the infrared pixel color band audio track is converted from color pixels into 3D stereo audio.

36. The apparatus of claim 1, further comprising:
an infrared laser intersecting points to spatial pixel points in such a way that audio waves and sound are generated at any spatial point target in a space managed by the illumination transformer audio video manager interactive server transmitter server node(s) system; and
a tenth mechanism where digital or quantum computer content can be projected through laser to infrared intersected target that creates an audio speaker at a spatial point in free space at spatial point target.

37. The apparatus of claim 1, further comprising:
a eleventh mechanism that identifies the front of a human face and the device automatically in real time creates zones at real time spatial point targets for left and right hearing zones, and left and right seeing zones, including a flat 2D viewing zone and a 3D viewing zone, along with a curved virtual zone, and targets those zones for binaural stereo audio listening, and 3D video projection, to where a user is and targets only that user area.

38. The apparatus of claim 1, further comprising:
an infrared laser with rotating mirror for creating a scan line in synchronization with another infrared laser to an intersecting point and scan lines created together to form a white background for free spatial point targeted array of projected pixels to create a reflection background for projection of video, images 3D, or 2D at a specific spatial point target zone for viewing in high definition or conventional definition; and
a twelfth mechanism enabling variable sized pixels for high definition viewing at a size, calculated by the illumination transformer audio video manager interactive server transmitter high resolution server node(s) comprising crystals, beam splitters, and intensity mechanism for optimal laser columnar size, and color.

39. The apparatus of claim 1, further comprising:
a thirteenth mechanism for projecting video, images, and text, created from a video or still camera, for high definition, and projecting large plurality of colors, that are wide spectrum varieties of the red, green, blue, and yellow combinations for an array of many colors of the spectrum, utilizing the server node(s) human retina emulator high resolution projection mechanism, and an interpolated system algorithm for converting red, green, blue, yellow, black, and white colors into a plurality of spectrum colors for projection and viewing by devices and in free spatial point targeted pixel arrays for non-device dependent projection applications.

40. The apparatus of claim 1, further comprising:
an active-pixel sensor infrared laser high resolution recorder device that includes a plurality of curved bowl shape sensors with active-pixel image combined with position related active pixel sensor imager infrared distance measurement recording mechanism, for recording of distance for processing in determining high resolution vision; and
where distance to object viewed at upper edge of active-pixel image sensor bowl through pixel image sensor lens is recorded and matched to the color sensors pixel position for same distance information, so that every pixel recorded has color information and distance information attached to it, the same recording of distance and color pixel information is aggregated from the whole surface of the active-pixel image bowl shaped sensor; and
by recording different perspective variations of the active-pixel image bowl sensor, a three dimensional recording can be made from a single active-pixel image bowl sensor.

41. The apparatus of claim 1, further comprising:
an active-pixel sensor laser high resolution projector device that includes a plurality of curved bowl shaped sensors combined with active-pixel sensor bowl shaped lasers that have the ability to project wide spectral array of colors to free spatial point pixel targets, each combined with position related active pixel sensor imager infrared distance measurement recording mechanism, for projection of precise distance for projecting in high resolution 2D or 3D.

42. The apparatus of claim 1, further comprising:
a server node mechanism to transmit a plurality of spectrum of colors to each pixel in a free spatial targeted zone.

43. The apparatus of claim 1, further comprising:
a wearable apparatus in fashions and clothing for recording, listening and viewing, ;
a wearable apparatus with cameras and microphone embedded in clothing and fashions that is used by the virtual reporter, virtual fan, virtual fan reporter, for recording content,
an automatic licensing mechanism that searches for users to purchase content.

44. The apparatus of claim 1, further comprising:
projecting an object to space in a free spatial point pixel targeted projection.

45. The apparatus of claim 1, further comprising:
one or more quantum cascade lasers that are used to detect minute traces of gases that absorb infrared light.

46. The apparatus of claim 1, further comprising:
a wearable apparatus in fashions and clothing for recording, listening and viewing network.

47. The apparatus of claim 1, further comprising:
wearable's fashions that have connectors built in for server node(s) network communication virtual reporter devices to be snapped in, or added to fashions to enable users to be virtual reporters, or virtual.

48. The apparatus of claim 1, further comprising:
a stator rotor mechanism can also be in the shaft of the main turbine cups, a main shaft attached to a plurality of wind cups turns a plurality of large horizontal gears, that turn a plurality of mini generators with a small gear attached all around the large gear, in a multiple setup of a plurality of electric cluster generators; and
the electric cluster generators can be inside the main server box and the same right angle grouping of gears for high torque can be used for driving the internal electric cluster generators.

49. The apparatus of claim 1, further comprising:
curved solar panels with wind energy turbines mounted for energy creation, and VOIP server node(s) for communication, linked to the illumination transformer audio video manager interactive server transmitter node(s) network;
a energy management mechanism and killowatt hour bank, linked to and from financial service institutions, for payment and processing of transactions;
free space projected advertisement billboards, with the ability to project other information as well as content while users are charging vehicles, or driving by; and
a fourteenth mechanism for downloading content and entertainment, and in addition the charging station can provide directional information and virtual maps, for download into wireless devices, or wired devices.

50. The apparatus of claim 1, further comprising:
a curved human retina emulator mechanism, for recording infrared night vision image
a database server node for interpolating, emulating and determining proper colors of facial areas, objects and backgrounds at different times of the day, and seasons to get the closest possible match of appropriate color of the detected objects; and
a database server node storing the recorded and transformed content.
